(19) United States
(12) Patent Application Publication
(10) Pub. No.: US 2007/0192084 A1
(43) Pub. Date: Aug. 16, 2007

(54) Induction of grammar rules

(76) Inventor: Stephen C. Appleby, Colchester (GB)

Correspondence Address: NIXON & VANDERHYE, PC, 901 NORTH GLEBE ROAD, 11TH FLOOR, ARLINGTON, VA, 22203, US

(21) Appl. No.: 10/592,801

(22) PCT Filed: Mar. 17, 2005
(86) PCT No.: PCT/GB05/01010

§ 371 Date: Sep. 14, 2006

(30) Foreign Application Priority Data
Mar. 24, 2004 (GB) 0406619.7

(51) Int. Cl. G06F 17/27

(52) U.S. Cl. 704/9

(57) ABSTRACT

A method of grammar rule induction comprises obtaining a monolingual set of phrases from a bilingual corpus of translation pairs. For each of the monolingual phrases in turn, initialising, with inactive edges formed from headwords identified in the phrase, the agenda of a dependency grammar chart parser arranged to form packed edges in the chart. Running the chart parser and adding to the agenda, for each inactive edge removed from the agenda, one or more active edges created as if all possible grammar rules existed. When the agenda is empty, ascertaining the alternations of each edge in the packed edge corresponding to the complete phrase, and finding their respective highest frequencies. For the set of phrases, summing, for each alternation, its respective highest frequencies, and ranking the sums. Then, selecting alternations in rank order to form the required set of grammar rules until the required set has become sufficient such that for each monolingual phrase there exists at least one analysis corresponding to the required set of grammar rules.

### BACKGROUND OF THE INVENTION

1. Field of the Invention

The present invention lies in the field of machine translation (MT) and relates particularly, but not exclusively, to a method of and an apparatus for generating, by automatic induction, a set of grammar rules for a given language, herein referred to, respectively, as the grammar rule induction method and the grammar rule induction apparatus, and also to a method of and an apparatus for generating, by automatic induction, a set of bilingual grammar rule pairs for a given pair of languages.

2. Related Art

Example-Based Machine Translation (EBMT) is an approach to engineering MT systems that involves creating new translations from combinations of fragments of examples from a corpus of aligned phrases, also referred to as phrase translation pairs. A review of EBMT systems can be found in the article “Review Article: Example-based Machine Translation” by H Somers, Machine Translation, Vol. 14, No. 2, 1999, pages 113 to 157. The original suggestion for this approach is generally ascribed to Makoto Nagao who in 1990 was the first to describe the various stages used, see the article “Toward Memory-based Translation” by S Sato and M Nagao, Proceedings of 13th International Conference on Computational Linguistics, Helsinki 1990 (COLING-90), pages 247 to 252. Since then, research has steadily grown in this area to produce a wide range of techniques with various advantages and limitations.

Two strands of EBMT are particularly relevant to the present invention, and these can be characterised according to the nature of their training data.

In a first of these strands, the training data is simply a corpus of aligned phrases with no structural analysis (though sometimes, morphological analysis is carried out). If unanalysed, aligned phrases are used as the training corpus, then a pattern-based approach might be to produce templates that can be re-combined to form new translations. See, for example, the articles “Learning Translation Templates from Examples”, by H A Guvenir and I Cicekli, Information Systems, Vol. 23, No 6, (1998), pages 353 to 363; and “A Language-Neutral Sparse-Data Algorithm for Extracting Translation Patterns”, by K McTait and A Trujillo, Proceedings of the 8^{th} International Conference on Theoretical and Methodological Issues in Machine Translation, TMI-99, Chester, UK, pages 98 to 108. For this reason, this approach is called “Pattern-Based MT”.

In the second strand, the aligned phrases of the corpus are annotated with a manual analysis and fine-grained alignment. This second strand has been called Data-Oriented Translation (DOT) by A Poutsma because of its connection with Data-Oriented Parsing (DOP). For information on DOT, see the article “Data-Oriented Translation” by A Poutsma, Proceedings of 9th meeting of Computational Linguistics in the Netherlands, Amsterdam (1998 CLIN), and for information on DOP, see “Data-Oriented Language Processing: An Overview” by R. Bod and R. Scha, (ILLC Research Report LP-96-13), Institute for Logic, Language and Computation, University of Amsterdam, The Netherlands, 1996.

There are advantages and disadvantages to both techniques. The main advantage of using unanalysed phrases as the training data is that a relatively small human effort is required to produce the training data, and, therefore, large quantities may be created for a given cost. For the same cost, an analysed, aligned corpus will be much smaller.

It is known that there is a clear relationship between Pattern-Based MT and Context Free Grammars (CFG), see the paper “Pattern-Based Context-Free Grammars for Machine Translation” by K Takeda, Proceedings of the 34th Annual Meeting of the Association for Computational Linguistics, 1996. In CFG, the format of the rules is a left hand side (e.g. M) and a right hand side (e.g. A, B, C . . . ), which expresses the situation where a sequence of terms with labels ‘A’, ‘B’, ‘C’ etc. can be replaced by a single term with label M.

Rules in this format are said to be ‘context-free’ since the left hand side contains precisely one term; other terms cannot be introduced to provide a context. These rules can be applied recursively, normally using a parser, to build up a parse tree which represents the analysis of some phrase.

It is known that CFGs do provide a first approximation to the structure of human language. However, it is also known that there are common linguistic phenomena that require substantial modification of the CFG model. Perhaps the most studied of these phenomena are so-called ‘unbounded dependencies’. Various methods have been proposed to extend CFGs to handle such phenomena. The most common approach is to add a mechanism which allows information to pass across the tree, thereby giving a limited context sensitivity to the rules. More information on this can be obtained from the article “Extraposition Grammars” by F Pereira, American Journal of Computational Linguistics, Vol. 7, No. 4, 1981, pages 243 to 256; the book “Generalised Phrase Structure Grammar” by G Gazdar, E Klein, G K Pullum and I A Sag, published by Harvard University Press, 1985; and the book “Head-Driven Phrase Structure Grammar” by C Pollard and I A Sag, published by The University of Chicago Press, 1994. Generalised Phrase Structure Grammar and Head-Driven Phrase Structure Grammar are generally referred to as GPSG and HPSD, respectively. In the art, and herein, the terms “head”, “headword” and “head word” are synonymous and are used interchangeably.

It is known that one of the limitations of basic CFGs is that they cannot adequately express the relationships present in unbounded dependencies. The result of this is that, even in a relatively simple case where source and target structures are very similar, the Pattern-Based approach will admit translations that are incorrect as a result of the constraints placed on the possible analyses by the underlying models. That is, the underlying representation will give poor “precision” in many cases.

It is also known that the restrictions imposed by the representation underlying Pattern-Based MT break the relationship between the head and its dependents for linguistic phenomena, such as unbounded dependencies, or where the source and target languages are structurally dissimilar. In these cases, Pattern-Based MT will achieve a poor precision/recall trade-off.

### SUMMARY OF THE INVENTION

In accordance with a first aspect of the invention there is provided a method of generating a set of grammar rules for a given language, referred to as the required set of grammar rules, comprising the steps:
(a) acquiring a set of phrases in the given language, those phrases existing in a corpus of phrase translation pairs;
(b) generating all possible grammar rules in respect of the set of phrases;
(c) generating, by an analysis generator and using said possible grammar rules, for each member of the set of phrases, all possible analyses;
(d) ascertaining, for each of the analyses, the respective alternations thereof;
(e) ranking the alternations in accordance with a predetermined criterion;
(f) responding to a trigger by actually or effectively transferring the current highest ranking alternation or alternations from the ranked list of alternations to a list of selected alternations and entering a trigger-waiting state; and
(g) responding actually or effectively to the entry of the trigger-waiting state by ascertaining whether there exists, for each member of the stored set of phrases, at least one analysis corresponding to the current list of selected alternations acting as grammar rules, and either generating a said trigger upon a negative outcome or taking no action upon a positive outcome, whereupon in this latter case the current list of selected alternations is then deemed to be the required set of grammar rules.

Thus, the present invention enables the automatic generation of grammar rules from a corpus of translation examples, and provides an alternative to the use of an expert linguist for producing grammar rules manually. The corpus can be generated by skilled translators, who can produce very accurate translations from experience without necessarily being able to state the grammar rules underlying the translations. In practice, such skilled translators are more numerous than expert linguists, and do not command such a high fee as would an expert linguist. Furthermore, for certain languages, there might not exist anyone who possesses sufficient linguistic knowledge to be deemed an expert, and in such cases the automatic induction of the required grammar rules by the present invention is the only way of obtaining the grammar rules.

Preferably, the ranking step (e) comprises the substeps:
(e1) ascertaining, for each analysis for a said phrase, respective frequencies of each of its alternations;
(e2) ascertaining, for all the possible analyses of the said phrase, respective highest frequencies of each of the alternations;
(e3) repeating substeps (e1) and (e2) for each remaining phrase of said set of phrases and ascertaining, for each of the alternations, the sum of the associated respective highest frequencies; and
(e4) ranking the alternations by their respective sums.

The step (c) may comprise the substeps:
(c1) parsing each respective member of the set of phrases with a dependency grammar chart parser having an agenda and a chart; and
(c2) forming packed edges in the chart.

Preferably, substep (c1) comprises the substep (c1.1) initialising the agenda with inactive edges formed from headwords identified in the respective member of the set of phrases.

More preferably, the substep (c1) further comprises the substep (c1.2) adding to the agenda, for each inactive edge removed from the agenda by the operation of the chart parser, one or more active edges created as if all possible grammar rules existed; and the step (b) is constituted by step (c).

The step (b) and step (c) together may be constituted by generating, by a dependency representation generator, for each member of the set of phrases, a respective set of all possible dependency representations, the dependency representations constituting said analyses.

In accordance with a second aspect of the invention there is provided an apparatus for generating a set of grammar rules for a given language, referred to as the required set of grammar rules, comprising:
a store for storing, in use, a set of phrases in the given language, those phrases existing in a corpus of phrase translation pairs;
a grammar rule generator for generating, for a set of phrases in the store, all possible grammar rules in respect of the set of phrases;
an analysis generator arranged to use the generated grammar rules for generating, for each member of the stored set of phrases, all possible analyses;
means for ascertaining, for each of the analyses, the respective alternations thereof;
means for forming a list of the alternations ranked in accordance with a predetermined criterion;
alternation selection means responsive to a trigger for changing from a quiescent state to an active state in which it actually or effectively transfers the current highest ranking alternation or alternations from the ranked list of alternations to a list of selected alternations and returns to its quiescent state; and
means responsive actually or effectively to the return of the alternation selection means to its quiescent state for ascertaining whether there exists, for each member of the stored set of phrases, at least one analysis corresponding to the current list of selected alternations acting as grammar rules, and being arranged to trigger the alternation selection means upon a negative outcome and to take no action upon a positive outcome, whereupon in this latter case the current list of selected alternations is then deemed to be the required set of grammar rules.

Preferably, the means for forming a list comprises:
means for ascertaining, for a said analysis, respective frequencies of each of the alternations thereof;
means for ascertaining, for all the possible analyses of a said phrase, respective highest frequencies of each of the alternations of those analyses;
means for summing, for all the phrases and for each of the alternations, the associated respective highest frequencies; and
means for ranking the alternations by their respective sums.

The analysis generator may be a dependency grammar chart parser having an agenda and a chart and arranged to form packed edges in the chart.

Preferably, there is included means for identifying headwords in a phrase and for initialising the agenda with inactive edges formed from headwords so identified.

Preferably, the grammar rule generator is arranged to add to the agenda, for each inactive edge removed from the agenda by the operation of the chart parser, one or more active edges created as if all possible grammar rules existed.

The grammar rule generator and the analysis generator together may be constituted by a dependency representation generator, the dependency representations constituting said analyses.

In accordance with a third aspect of the invention there is provided a method of generating a set of bilingual grammar rule pairs for a given pair of languages, referred to as the required set of grammar rule pairs, comprising the steps:
(a) acquiring a first set of phrases in a first of the pair of languages and a corresponding second set of phrases in the second of the pair of languages, said first and second sets of phrases constituting a set of phrase translation pairs in the given pair of languages;
(b) generating all possible grammar rules in respect of said first set of phrases;
(c) generating, by an analysis generator and using said possible grammar rules, for each member of said first set of phrases, all possible analyses;
(d) ascertaining, for each of the analyses, the respective alternations thereof;
(e) applying steps (b) to (d) to said second set of phrases, mutatis mutandi, and
(f) ascertaining each alternation of the respective alternations of said first set of phrases which is aligned with an alternation of the respective alternations of said second set of phrases, each such aligned pair of alternations being referred to as an alternation pair;
(g) ranking the alternation pairs in accordance with a predetermined criterion; and
(h) making the highest ranking alternation pair or alternation pairs a member or members of a set of selected alternation pairs, and similarly for the next highest ranking alternation pair or alternation pairs, and so on, and ceasing when the set of selected alternation pairs acting as grammar rule pairs has become sufficient such that for each member of the set of phrase translation pairs there exists, for each of the phrases of the particular member, at least one analysis corresponding to the set of selected alternation pairs whereupon the current list of selected alternation pairs is then deemed to be the required set of grammar rule pairs.

Preferably, in this third aspect, the ranking step (g) comprises the substeps:
(g1) ascertaining, for each analysis for each phrase of a phrase translation pair, respective frequencies of the alternations of each alternation pair;
(g2) ascertaining, for each alternation of an alternation pair and for all the possible analyses of the said phrase, respective highest frequencies of each of the alternations;
(g3) ascertaining, for each alternation pair and for each of the translation pairs, the lower of the highest frequency in respect of the analyses of the phrases in the first language and the highest frequency in respect of the analyses of the phrases in the second language;
(g4) repeating substeps (g1) and (g2) for each remaining phrase of said set of phrases and ascertaining, for each of the alternation pairs, the sum of the associated respective lower highest frequencies; and
(g5) ranking the alternations by their respective sums.

In this third aspect, the step (c) may comprise the substeps:
(c1) parsing each respective member of the first set of phrases with a dependency grammar chart parser having an agenda and a chart; and
(c2) forming packed edges in the chart.

Preferably, in this third aspect, the substep (c1) comprises the substep (c1.1) initialising the agenda with inactive edges formed from headwords identified in the respective member of the first set of phrases.

More preferably, in this third aspect, the substep (c1) further comprises the substep (c1.2) adding to the agenda, for each inactive edge removed from the agenda by the operation of the chart parser, one or more active edges created as if all possible grammar rules existed;
and step (b) is constituted by step (c).

In this third aspect, the step (b) and step (c) together may be constituted by generating, by a dependency representation generator, for each member of the first set of phrases, a respective set of all possible dependency representations, the dependency representations constituting said analyses.

In accordance with a fourth aspect of the invention there is provided an apparatus for generating a set of bilingual grammar rule pairs for a given pair of languages, referred to as the required set of grammar rule pairs, comprising:
a store for storing a first set of phrases in a first of the pair of languages and a corresponding second set of phrases in the second of the pair of languages, said first and second sets of phrases constituting a set of phrase translation pairs in the given pair of languages;
a grammar rule generator for generating, for a stored set of phrases, all possible grammar rules in respect of the set of phrases;
an analysis generator arranged to use the generated grammar rules for generating, for each member of the stored set of phrases, all possible analyses;
means for ascertaining, for each of the analyses, the respective alternations thereof;
means for ascertaining each alternation of the respective alternations of said first set of phrases which is aligned with an alternation of the respective alternations of said second set of phrases, each such aligned pair of alternations being referred to as an alternation pair;
means for forming a list of the alternation pairs ranked in accordance with a predetermined criterion; and
means for creating the required set of grammar rule pairs by repeated operation of actually or effectively transferring the current highest ranking alternation pair or alternation pairs from the ranked list of alternation pairs to a list of grammar rule pairs and then checking whether there exists, for each phrase of each member of the stored set of phrase translation pairs, at least one analysis corresponding to that list of grammar rule pairs, and being arranged to cease operation upon a positive outcome of that check, the said list of grammar rule pairs being then deemed to be the required set of grammar rule pairs.

Preferably, in this fourth aspect, the means for forming a list comprises:
means for ascertaining, for a said analysis, respective frequencies of each of the alternations thereof;
means for ascertaining, for all the possible analyses of a said phrase, respective highest frequencies of each of the alternations of those analyses;
means for ascertaining, for each alternation pair and for each of the translation pairs, the lower of the highest frequency in respect of the analyses of the phrases in the first language and the highest frequency in respect of the analyses of the phrases in the second language;
means for summing, for all the phrases and for each of the alternations, the associated respective lower highest frequencies; and
means for ranking the alternations by their respective sums.

In this fourth aspect, the analysis generator may be a dependency grammar chart parser having an agenda and a chart and arranged to form packed edges in the chart.

Preferably, in this fourth aspect, there may be included means for identifying headwords in a phrase and for initialising the agenda with inactive edges formed from headwords so identified.

Preferably, in this fourth aspect, the grammar rule generator is arranged to add to the agenda, for each inactive edge removed from the agenda by the operation of the chart parser, one or more active edges created as if all possible grammar rules existed.

In this fourth aspect, the grammar rule generator and the analysis generator together may be constituted by a dependency representation generator, the dependency representations constituting said analyses.

### BRIEF DESCRIPTION OF THE DRAWINGS

Preferred embodiments of an apparatus and a method of the present invention will now be described by way of example with reference to the drawings, in which:

FIG. 1 shows a general purpose computer system which provides the operating environment of embodiments of the present invention;

FIG. 2 shows a system block diagram of the system components of the computer system 1;

FIGS. 3 to 21 show dependency representations of various analyses of the phrase “the cat sees a dog”; and

FIGS. 22 to 40 show dependency representations of various analyses of the phrase “a bear eats the fish”.

### DETAILED DESCRIPTION OF THE PREFERRED EMBODIMENTS

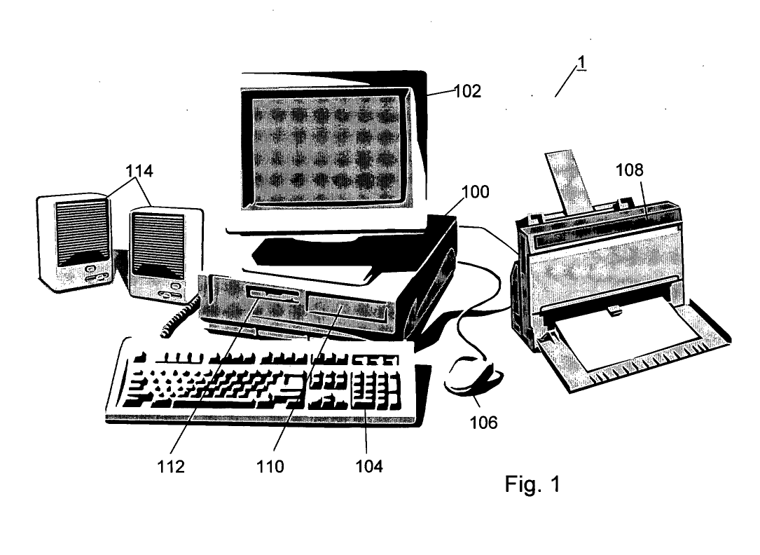

FIG. 1 shows a general purpose computer system which provides the operating environment of embodiments of the present invention. Later, the operation of the embodiments of the present invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which may form the operating environment of an embodiment of an invention, and which is generally known in the art comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a laptop or notebook configuration. Other configurations such as personal digital assistants or even mobile phones may also be possible.

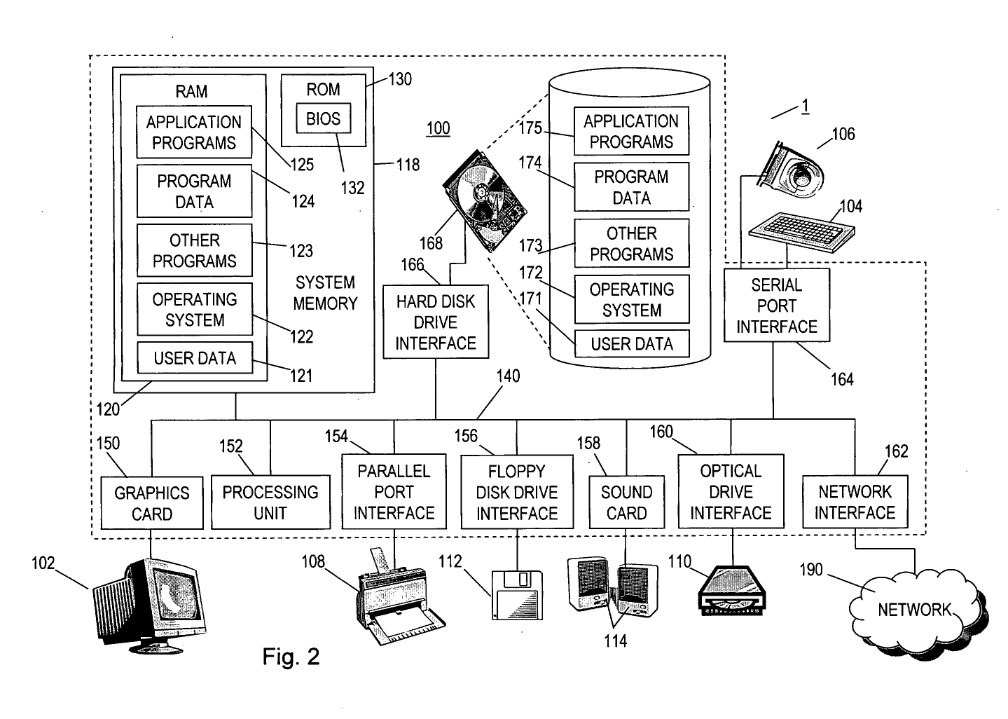

FIG. 2 shows a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs 173 required by the computer system 1 or the user, a computer system operating system 172 such as Microsoft® Windows®, Linux™, UniX™, or the like, as well as user data in the form of files, data structures, or other data 171. The hard disk drive 168 provides non-volatile storage of the aforementioned programs and data such that the programs and data can be permanently stored without power. The other programs 173 include a program or programs for implementing methods of the present invention (i.e. a program for generating a set of grammar rules of the present invention a program for generating a set of bilingual grammar rules of the present invention), and the user data 171 includes a bilingual (English-French) corpus of pairs of phrases (typically sentences) that are translations of one another. In a variant, the applications programs 175 contain program or programs for implementing methods of the present invention.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow the system to boot-up.

Whilst FIG. 2 illustrates one embodiment of the invention, it will be understood by the skilled person that other peripheral devices may be attached to the computer system, such as, for example, microphones, joysticks, game pads, scanners, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, it should further be understood that the application programs, other programs, and other data which may be stored locally in the computer system may also be stored, either alternatively or additionally, on remote computers, and accessed by the computer system 1 by logical connections formed over the network 190.

The starting point for the grammar rule induction method of the present invention is a corpus of pairs of phrases (typically sentences), where each pair of phrases comprises a respective phrase in a common source language together with its linguistic equivalent in a common target language. It does not matter whether, for any particular one of the pairs of phrases, the target language phrase was produced by translating the source language phrase, or whether the source language phrase was produced by translating the target language phrase. Such a pair of phrases is herein referred to as a phrase translation pair, or simply a translation pair, or an example, and such a corpus is herein referred to as a translation pair corpus or a training corpus. The corpus is contained within the user data 171 of the computer system 1.

Firstly, a lexical alignment is performed to indicate, in each of the pairs of phrases, aligned words (referred to as headwords) in the source and target languages. This will involve the use of a dictionary contained within user data 171, and be performed by a computer program contained within the other programs 173. Alternatively, the lexical alignment is performed manually by a person skilled in the art. This lexical alignment will include recognition of, say, the same proper name, or the same date, in the source and target languages, and for this purpose might involve special recognition algorithms.

The dependency analyses produced by context-free grammar (CFG) rules are planar trees, wherein all non-headwords are leaves. Since it is not known what the grammar is, initially all such trees have to be considered as possibilities. For any given phrase pair, there will typically be a very large number of topologically legal analyses.

In order to select the dependency analysis, and therefore the grammar, which is likely to be correct, a first preferred embodiment of the present invention applies two criteria. One is the use of minimum description length (MDL) approach to optimisation, and the other is that a head word determines its daughters. For a background to the minimum description length criterion, the reader is referred to the publication “Machine Learning” by T Mitchell, McGraw-Hill International Editions, 1997; the paper ““Generalizing Case Frames Using a Thesaurus and the MDL Principle” by H Li and N Abe, Computational Linguistics, Vol. 24, No. 2, pages 217 to 244; and the paper “Learning Dependencies between Case Frame Slots” by H Li and N Abe, Computational Linguistics, Vol. 25, No. 2, pages 292 to 303.

For the purpose of the present invention, an informal definition of description length is adequate, this being the number of distinct alternations required to analyse a corpus of examples. As is known in the art, in the monolingual DOT case, an alternation is defined as a grammar rule with the headword replaced by a generic headword marker symbol, and in the Pattern-based case, an alternation pair is defined as a synchronised pair of rules with source and target heads replaced by a generic head marker symbol. For more information on alternations the reader is referred to the publication “English Verb Classes and Alternations: A Preliminary Investigation” by Beth Levin, The University of Chicago Press, 1993.

The intention of this preferred embodiment of the present invention is to find the smallest number of distinct alternations such that, when headwords are re-inserted in place of the head marker symbols, they produce grammar rules that are capable of providing an analysis for every translation pair in the training corpus.

In a second preferred embodiment of the present invention to be described later, this is achieved by producing every possible analysis which corresponds to a legal topology, i.e. a planar tree in one of the languages which is isomorphic to some planar tree in the other of the languages, decomposing each analysis into grammar rules, removing the heads from these rules to make alternations, then observing the distributions of the alternations. To be certain of having the minimal set, it would be necessary to try every possible subset of alternations which is capable of forming grammar rules which analyse the whole corpus, and select the smallest such subset.

This approach would be practicable only for small corpora. So, a simplifying assumption is made that the most frequent alternations will tend to be members of the minimal set. Conversely, it can be said that the minimal set is unlikely to include infrequent alternations, and, in practice, the preferred embodiment adopts this latter approach by stipulating that the analysis that is selected for any example will be that which has the highest minimum frequency alternation. That is, for each analysis for a given example, the lowest frequency of the alternations used in that analysis is found. Then the embodiment selects the analysis for that phrase that has the highest such frequency as being most likely to be correct.

Because the actual frequency of occurrence of the alternations will not be known until the correct analyses are known, the actual frequency of occurrence of the alternations cannot be used to determine the best analysis. Instead, this preferred embodiment uses estimates of the frequencies which are calculated by finding the highest number of times that an alternation can occur in any one analysis of each phrase (referred to herein as the “highest frequency”), then summing the respective highest counts over all phrases. This is the most optimistic view of the number of times that an alternation could appear in the correct analyses of the phrases.

In summary, the frequency counts have been defined and the manner in which they will be used to estimate the minimal subset of alternations required to analyse the translation pair corpus has been described. An algorithm, referred to as the count alternations function, for calculating these frequencies will be described in detail later.

It has already been mentioned that the number of topologically plausible analyses can be very large. Therefore, this preferred embodiment of the present invention seeks to estimate the frequencies of the alternations for inducing monolingual grammar rules (and bilingual synchronised grammar rules) without having to produce every possible analysis. In particular, the preferred method counts frequencies for alternations in all possible analyses of a text, without the need to create these analyses explicitly. The approach is to use a chart parser modified for the specific purposes of the present invention. In order that the reader will be able to understand the operation of the present invention more readily, the normal operation of a conventional chart parser will now be described. For more detailed information, the reader is referred to the book “Natural Language Processing in Lisp” by Gerald Gazdar and Chris Mellish, published by Addison Wesley, 1989, ISBN 0201178257.

A Conventional Chart Parser for Dependency Grammars

The objective of a conventional chart parser is to produce one or more analyses of an input text, given a grammar. An efficient chart parser will do this in a way that does not repeat any attempt to analyse a portion of the text. To achieve this, a chart parser uses two key data structures: a chart and an agenda. Both the agenda and the chart are arranged to store, during processing, data structures known in the art as “edges”. The agenda is for storing a list of edges yet to be processed by the chart parser. The chart is for storing the results of processing the edges in the agenda.

An edge can be thought of as an instance of a grammar rule. An edge includes information representing the progress of application of the rule to the input text.

Edges can be one of two activity types, “active” or “inactive”. Another way of expressing this is to say that edges are either “active” or “inactive”. An active edge is one that still requires more terms to be found to satisfy the grammar rule on which it is based. Conversely, an inactive edge is complete, in that it does not require any more terms to be found to satisfy its grammar rule. Each edge is associated with a respective activity marking, i.e. “(left active)”, “right active”) or “(inactive)”, and this marking is checked and updated, as necessary, each time that the edge is extended. An edge that is left active can be extended only on its left side, and similarly an edge that is right active can be extended only on its right side.

Two versions of conventional chart parser are known. A first version is used with phrase-structure grammars, and a second version, derived from the first version, is used with dependency grammars. In the first version, the parser works from left to right of the input text. In the second version, the parser works from the head word outwards, and the order in which the daughters are considered is constrained. Furthermore, in this second version, a search for daughters to the right of a head word is not performed until a search for daughters to the left of that head word has been completed, i.e. all the left hand daughters have been found. Thus, there are two types of active edge (rule), namely left active and right active, with the restriction that an edge, or rule, can only be right active if it is not left active. This is to avoid spurious ambiguities. An alternative form of dependency grammar chart parser is known which uses the inverse of this constraint and restriction, i.e. a search for daughters to the left of a head word is not performed until a search for daughters to the right of that head word has been completed, and a rule can only be left active if it is not right active.

To see how edges are formed, and how a known dependency grammar chart parser operates, consider the following example.

Suppose that it is desired to analyse the following input text,

0 the 1 dog 2 sees 3 the 4 cat 5

(where, as is known in the art, the numerals are used to identify positions of “vertices”-vertex “0” denoting the start of the input text, and vertex “5” being found to be the highest numbered vertex needed for this particular input text) with the following grammar,

A <sees> the B
the <dog>
<cat>

An initial set of edges is created by searching the grammar for rules whose head words match the input text. For each such match an edge is created and stored in the agenda. The initial set of edges corresponding to the above example is,

A | <sees> | the B : (2,3) : (left active)
the | <dog> | : (1,2) : (left active)
| <cat> | : (4,5) : (inactive)

where,
the two vertical bars, |, in an edge indicate the start position and finish position of the part of that grammar rule that has been matched so far; the pairs of numbers in brackets indicate the respective positions of the two vertices defining the start and finish of that part of the input text spanned by the edge so far, i.e. the “span”, and are therefore referred to herein as the span descriptor (SD); and the edge activity type is either left active, right active or inactive.

The first two of these edges are referred to as active edges since the whole rule is not matched, i.e. the rule is not wholly between the start and finish vertices of the edge. The last edge is referred to as an inactive edge as it does not require any further terms to be found to complete the grammar rule, i.e. the rule does lie wholly within the start and finish vertices of the edge.

In operation, the chart parser removes, i.e. extracts, an edge from its agenda, usually the edge which is at the top of the list of edges in the agenda, and processes that edge in accordance with its controlling program, also referred to herein as the parsing algorithm or algorithm. In a first step, the algorithm ascertains whether the edge is active (left or right) or inactive. If the edge is left active, the algorithm tries to find terms to match its left daughter, and if the edge is right active, the algorithm tries to find terms to match its right daughter.

If a daughter in an active edge is a literal word, the algorithm attempts to match that literal word against a literal word in the text in the same position with respect to the marked head word as that daughter is with respect to the head word of the edge. On the other hand, if the daughter in that active edge is a variable, the algorithm attempts to match an inactive edge in the chart against a word in the text in the same position with respect to the marked head word as that variable daughter is with respect to the head word of the edge. If a match is found between a variable daughter and an inactive edge, then the algorithm stores a link between that variable and the inactive edge in order to be able to recover the analysis.

Whenever, during processing of an active edge, the algorithm successfully finds a match for a daughter against an inactive edge, or a literal word, it creates from that original active edge a new edge, this is referred to as “extending” the active edge, by updating the span descriptor, and the edge activity type, as appropriate, and adding that new edge to the top of the list of edges in the agenda, also referred to as adding the edge to the top of the agenda, or just adding it to the agenda. Then, finally, the originally removed edge is added to the chart.

The conventional DG chart parsing algorithm can thus be summarised as,
Using the grammar, prime the agenda with edges,
Until the agenda is empty,

Remove an edge from the agenda and add it to the chart,
If the removed edge is active,

Create from that removed edge a respective extended edge for
each literal word in the input text that can extend that
removed edge and also for each inactive edge in the chart
that can extend that removed edge,
Add all such extended edges to the agenda,

If the removed edge is inactive,

Create a respective extended edge for each active edge in
the chart that the removed edge can extend,
Add all such extended edges to the agenda.

There exists a valid analysis for the input text if, at the end of parsing, there exists in the chart an inactive edge that spans the whole of the text.

Consider now the analysis of the input text referred to above,

the dog sees the cat

Assuming the initial set of edges stated above, the algorithm first removes the edge “A|<sees>| the B: (2,3): (left active)”. It is found to be a left active edge, and as the left daughter is not a literal, the search for a matching literal in the input text is omitted, and a search is conducted in the chart for an inactive edge to match the left daughter. The chart is empty, so this edge is added to the chart.

The agenda and chart then contain:

Agenda

the | <dog> | : (1,2) : (left active)
| <cat> | : (4:5) : (inactive)

Chart

A | <sees> | the B : (2,3) : (left active)

Next, the edge “the |<dog>|: (1,2): (left active)” is removed from the agenda. Again, it is found to be a left active edge, but this edge requires a match for a literal word (“the”) to the left of its span descriptor, i.e. in the position “0,1”. This word is found in the text and so this edge is extended. The original edge, “the |<dog>|: (1,2): (left active)”, is added to the chart, and the newly created edge, “| the <dog>|: (0,2): (inactive)” is added to the bottom of the agenda to give:

Agenda

| <cat> | : (4:5) : (inactive)
| the <dog> | : (0,2) : (inactive)

Chart

A | <sees> | the B: (2,3) : (left active)
the | <dog> |: (1,2) : (left active)

Next, the edge “|<cat>|:(4,5): (inactive)” is removed from the agenda. It is found to be an inactive edge, so a search is conducted for both left active and right active edges in the chart that can be extended by it. No such edge is found, so the only action is the addition of this edge to the chart to give:

Agenda

| the <dog> | : (0,2) : (inactive)

Chart

A | <sees> | the B : (2,3) : (left active)
the | <dog> | : (1,2) : (left active)
| <cat> | : (4:5) : (inactive)

Next, the edge “| the <dog>|: (0,2): (inactive)” is removed from the agenda. It is found to be an inactive edge, so a search is conducted in the chart for any left active or right active edges that can be extended by it. The search finds “A |<sees>| the B: (2,3): (left active)”, and, therefore, a new edge “| (the <dog>) <sees>| the B: (0,3): (right active)” is formed, where parentheses are used to indicate the nesting structure of the analysis, i.e. that “the <dog>” is governed by “A <sees>the B”. This new, extended, edge is added to the agenda, and the original edge, i.e. “| the <dog>|: (0,2): (inactive)”, is added to the chart to give:

Agenda

| (the <dog>) <sees> | the B : (0,3) : (right active)

Chart

| the <dog> | : (0,2) : (inactive)
A | <sees> | the B : (2,3) : (left active)
the | <dog> | : (1,2) : (left active)
|<cat>| : (4:5) : (inactive)

Next, the edge “| (the <dog>) <sees>| the B: (0,3): (right active)” is removed from the agenda. It is found to be a right active edge, so it requires a match for its literal right daughter “the”. This word is found in the input text, so a new, extended, edge “| (the <dog>) <sees>the | B: (0,4): (right active)” is created and added to the agenda. The chart and agenda become:

Agenda

| (the <dog>) <sees> the | B : (0,4) : (right active)

Chart

| (the <dog>) <sees> | the B : (0,3) : (right active)
| the <dog> | : (0,2) : (inactive)
A | <sees> | the B : (2,3) : (left active)
the | <dog> | : (1,2) : (left active)
| <cat> | : (4:5) : (inactive)

Next, the edge “| (the <dog>) <sees> the | B: (0,4): (right active)” is removed from the agenda. It is found to be a right active edge, so it requires an inactive edge to match its right daughter. A search of the chart finds “|<cat>|: (4,5): (inactive)”, and a new, extended, edge is created, “| (the <dog>)<sees> the (<cat>)|: (0,5): (inactive)”, which is added to the agenda. The chart and agenda become:

Agenda

| (the <dog>) <sees> the (<cat>) | : (0,5) : (inactive)

Chart

| (the <dog>) <sees> | the B : (0,3) : (right active)
| the <dog> | : (0,2) : (inactive)
A | <sees> | the B : (2,3) : (left active)
the | <dog> | : (1,2) : (left active)
| <cat> | : (4:5) : (inactive)
| (the <dog>) <sees> the | B : (0,4) : (right active)

Finally, the edge “| (the <dog>) <sees> the (<cat>)|: (0,5): (inactive)” is removed from the agenda. It is found to be an inactive edge, and no active edge is found in the chart capable of extending it, so it is just added to the chart to give:

Agenda

Empty

Chart

| (the <dog>) <sees> | the B : (0,3) : (right active)
| the <dog> | : (0,2) : (inactive)
A | <sees> | the B : (2,3) : (left active)
the | <dog> | : (1,2) : (left active)
| <cat> | : (4:5) : (inactive)
| (the <dog>) <sees> the | B : (0,4) : (right active)
| (the <dog>) <sees> the (<cat>) | : (0,5) : (inactive)

The chart now contains a single inactive edge whose span descriptor “(0,5)” indicate that this edge spans the whole of the input text from vertex “0” to vertex “5”, already known to be the highest numbered vertex for this input text. Thus, this edge represents the analysis of the input text.

A conventional analysis recovery algorithm uses the span descriptor of the input text “(0,5)” and looks in the chart for an inactive edge having the same values of span descriptor. In other words, such an inactive edge would span the whole of the input text. For each daughter of this edge, the inactive edges that are the analyses of the variable daughters of that edge are sought. This continues recursively, until the whole of the tree for the analysis has been recovered. If there is more than one analysis, there will be more than one top-level edge, each corresponding to a distinct analysis.

Although the above parsing algorithm is much more efficient than other parsers, such as a backtracking parser, it still has one major inefficiency. There may be spans of text which have several analyses which are functionally equivalent. That is, any of the analyses may be used in place of the others to produce a grammatically valid analysis. When the parser is looking to extend an active edge, all that matters is that there exists at least one inactive edge which can be used to extend the active edge. With a conventional chart parser as described above, one new edge would be produced for each inactive edge capable of extending the active edge. This will lead to the chart parser repeating work.

The known solution commonly adopted for this is to “pack” functionally similar inactive edges into a “packed edge”. As far as the chart parser is concerned, a packed edge looks like a single edge, but may contain a number of alternative analyses. The present invention employs this packing technique, treating all inactive edges with the same span descriptor as functionally equivalent, and packing them into a common packed edge.

To extend an active edge by matching a variable daughter, the present invention matches against packed edges instead of individual edges. This means that a link is retained from the variable to the packed edge, instead of to the individual edges.

Thus a modified chart parsing algorithm including this packing is,
Using the grammar, prime the agenda with edges,
Until the agenda is empty,

Remove an edge from the agenda and add it to the chart,
If the removed edge is left active or right active,

Create from the removed edge a respective extended edge for
a literal word in the input text that can extend the removed
edge at its extendible side or for a packed edge in the chart
that can extend the removed edge at its extendible side,
Add any such extended edge to the agenda,

If the removed edge is inactive,

If there exists a packed edge having the same span as the
removed edge,

Add the removed edge to that packed edge,

Else,

Create a new packed edge and add the removed edge to it,
Create a respective extended edge for each active edge
in the chart that the new packed edge can extend,
Add all such extended edges to the agenda.

When packing is used, the procedure for extracting the complete set of analyses is a little more complicated. This procedure starts by looking for a top-level packed edge that spans the whole of the input text. This packed edge might contain more than one individual edge. For each variable daughter within each individual edge of this packed edge, all possible analyses are recursively found for the packed edge spanned by each daughter. This recursion continues until an edge is encountered having no variable daughter.

Using packing it is possible to store a very large number of analyses within a relatively small amount of memory, since common factors in different analyses are only stored once. Further, since the chart parser of the present invention processes all functionally equivalent items as a single unit, it does much less work.

Modifications to the Conventional Chart Parser to Produce all Possible Analyses

A modified chart parser as used in the first preferred embodiment of the present invention will now be described. It will be understood by the skilled person that the chart parser is embodied by a program contained within other programs 173 and that the agenda and chart are embodied by suitable portions of the memory 168.

As mentioned above, it is required to be able to deem alternations valid based on their frequency of occurrence in possible analyses of the examples. In many cases, though, there will be a great number of possible analyses. Accordingly, the modified chart parser has been designed to count the frequencies of occurrence without producing every analysis.

Suppose that a grammar was available containing all possible grammar rules. Such a grammar would, theoretically, be infinitely large. If this grammar was run on some input text, a chart would be produced whose packed edges contained every possible analysis of that text in packed form. Although the number of analyses might be very large, the storage required for the chart is likely to be small enough to be manageable on practical computer systems.

For an n word text, there are n.(n−1)/2 possible spans. Therefore, there are at most n.(n−1)/2 packed edges in the chart. For a 50 word sentence, this is a maximum of only 1225 packed edges.

Such a chart can be obtained by modifying the conventional chart parser to generate edges as required, as if every possible grammar rule existed. This is achieved as follows.

The starting point is an input text (say, one of the English phrases in the bilingual corpus 173) in which the headwords have been marked by a headword identifier program contained within other programs 173 and constituting a means of the present invention for identifying headwords in a phrase. In a variant method, the headwords are marked by a person skilled in the grammar of the language of that input text.

The chart parser is primed by creating inactive edges which span just the head words and putting these on the agenda, this being performed automatically by the computer/chart parser.

In accordance with the present invention, in addition to having an activity marking, edges have an augmentation marking, which is either “left-right augmentable” or “right-only augmentable”. The initially created inactive edges are initially marked as “left-right augmentable”. As used herein, the terms “augmentable” and “augmented” refer to the association of a term (the “augmentation”) with an inactive edge, at its left or its right, as appropriate, without updating the span descriptor of the inactive edge. This distinguishes from the concept of extending edges, as described above, where, for example, the edge

the | <cat> |: (1,2) (left active)

becomes extended to

| the <cat> |: (0,2) (inactive)

When an inactive edge marked as “left-right augmentable” is augmented to its left, its activity marking is changed to “left active” and it retains its “left-right augmentable” marking. However, when an inactive edge marked as “left-right augmentable” is augmented to its right, its activity marking is changed to “right active” and its “left-right augmentable” marking is replaced by a new marking of “right-only augmentable”. When an edge marked as “right-only augmentable” is augmented to its right, it retains that “right-only augmentable” marking. For convenience, the term “right augmentable” is also used herein, synonymously and interchangeably with “right-only augmentable”.

The algorithm (method) of the modified chart parser of the present invention performs additional steps over and above those of the conventional chart parser. These additional steps are: for each inactive edge that it removes from the agenda, ascertaining the augmentation marking of that edge, creating new, active edges from this inactive edge as described below, and the step of adding these newly created active edges to the agenda.

In this modified chart parser of the present invention, edges are removed from the top of the agenda and added to the top of the agenda. In a first alternative arrangement, edges are removed from the bottom of the agenda and added to the bottom, in a second alternative arrangement, edges are removed from the top of the agenda and added to the bottom, and in a third alternative arrangement, edges are removed from the bottom of the agenda and added to the top of the agenda. The common feature of all these arrangements is that the process continues until the agenda is empty, so as to ensure that all possible analyses are generated.

As an aid in understanding this step of creating new, active edges, let leftWord represent an adjacent literal in the input text to the left of the left-right augmentable inactive edge, and correspondingly for rightWord. Herein, the terms “adjacent” and “neighbouring” are used synonymously and interchangeably.

If an initial inactive edge is written as,

|<head>| : (n,m) : (inactive, left-right augmentable)

the edge creating step of the present invention mentioned above creates as many of the following four new, active edges as is possible,

leftWord |<head>| : (n,m) : (left active, left-right augmentable)

|<head>| rightWord : (n,m) : (right active, right augmentable)
X |<head>| : (n,m) : (left active, left-right augmentable)
|<head>| Y : (n,m) : (right active, right augmentable)

It might not be possible to create one or more of these four new, active edges. For example, there might not be an adjacent word in the input text to the left of the inactive edge and therefore the first and third new, active edges cannot be created, and similarly for the second and fourth new, active edges when there is no word in the input text to the right of the inactive edge. Furthermore, if there exists an adjacent word in the input text to the left (or to the right) of the inactive edge, and that adjacent word is a head word, then this cannot be used as a literal to create the first (or the second) new, active edge.

This edge creating step leaves the initial augmentation marking of left-right unaltered for each new, active edge that has a new term to its left, i.e. has a left augmentation (first and third new, active edges), but alters this initial augmentation marking to right-only for each new, active edge that has a new term to its right (second and fourth new, active edges). In this preferred embodiment, it is not permitted to create a new, active edge having both a new term to its left and a new term to its right.

For an inactive edge which has been produced by extending a right active edge, for example,
|. . . <head>. . . |: (n,m) (inactive, right augmentable)

the edge creating step of the present invention mentioned above creates one or both of the following new, active edges, as is possible,

|...<head>...| rightWord : (n,m) : (right active, right augmentable)
|...<head>...| Y : (n,m) : (right active, right augmentable)

As mentioned above, if there is no adjacent word in the input text to the right of the inactive edge, then neither of these new, active edges can be created, and if the word in the input text to the right of the inactive edge is a head word, then this cannot be used as a literal to create the first of these new, active edges.

All newly created, active edges are added to the agenda and processed in the same way as any other edge in the agenda.

In the above example, the agenda will initially contain the left-right augmentable, inactive edges

|<cat>| : (1,2) : (inactive, left-right augmentable)
|<sees>| : (2,3) : (inactive, left-right augmentable)
|<dog>| : (4,5) : (inactive, left-right augmentable)

Suppose now that the edge

|<sees>| : (2,3) : (inactive, left-right augmentable)

is removed from the agenda for processing. The algorithm will find that the input text contains the words “cat” to the left, and “the” to the right, of that edge, and so the following edges are created

| <sees> | the : (2,3) : (right active, right augmentable)
X | <sees> | : (2,3) : (left active, left-right augmentable)
| <sees> | Y : (2,3) : (right active, right augmentable)

Note that

cat | <sees> | the : (2,3) : (right active, right augmentable)

would not be created because “cat” is a head word and cannot be used as a
literal.
However, for the inactive edge

| <dog> | : (4,5) : (inactive, left-right augmentable)

as there is no word in the input text to the right of this inactive edge, the
following edges are created

the | <dog> | : (4,5) : (left active, left-right augmentable)
X | <dog> | : (4,5) : (left active, left-right augmentable)

The outline of the modified chart parser algorithm of the present invention is therefore,

Determine the head words of an input text, prime the agenda with inactive
edges created from those head words, each such inactive edge having a
corresponding span descriptor, an activity marking and an augmentation
marking, the activity marking being initially selected to be inactive
from a set of inactive, left active and right active, and the
augmentation marking being initially selected to be left-right from a set
of left-right and right-only,
Until the agenda is empty,

Remove an edge from the agenda,

(A) If the removed edge has an activity marking of left
active or right active,
Create from the removed edge a respective extended edge
for (A1) a literal word in the input text that can
extend the removed edge at an extendible side or for (A2)
a packed edge in the chart that can extend the removed
edge at an extendible side, and for each respective
extended edge update its span descriptor and, as
appropriate, its activity marking,
Add any such extended edge to the agenda,

Add the removed edge to the chart,
(B) If the removed edge has an activity marking of inactive,

If there exists in the chart (B1) a packed edge having
the same span descriptor as the removed edge, add the
removed edge to that existing packed edge,
Else, create in the chart (B2) a new packed edge for
the span descriptor of the removed edge and store the
removed edge in it,
Create a respective extended edge for (B21) each active
edge in the chart that the new packed edge can extend,
and for each respective extended edge update its span
descriptor and its activity marking accordingly,
Add all such extended edges to the agenda,

If the augmentation marking of the removed edge is (B3) left-right,
ascertain from the input text such (B31) left and (B32) right
neighbouring words as exist with respect to the removed edge,
create from the removed edge a set of all possible active edges
in which each active edge has either a left augmentation or a
right augmentation, but not both left and right augmentations, and
for each such active edge having a right augmentation changing its
activity marking to right-only,
Else, ascertain from the input text such (B4) right neighbouring
word as exists with respect to the removed edge, create from the
removed edge a set of all possible active edges in which each
active edge has a right augmentation,
all such augmentations being either (B41) the corresponding
neighbouring word or (B42) a placeholder symbol, with the proviso
that an augmentation cannot be the corresponding neighbouring word
if that corresponding neighbouring word is a head word,
Add the set of all possible active edges to the agenda.

In the above algorithm, the identifiers in italic, e.g. “(B42)”, refer to corresponding steps in an example of the operation of a chart parser included at Appendix A.

It will be understood that an active edge can be either left active or right active, but not both left active and right active at the same time.

Now that a chart can be produced which contains every possible analysis, the frequency counts of the alternations can be extracted using the following recursive function, referred to herein as the “count alternations function”, similar to that used for extracting analyses. In this high-level formulation of the function, for the sake of simplifying the detailed expression, ACounts and ECounts are stated to be initialised to zero before any other action takes place. However, in a working embodiment of this recursive function, the initialisation of the associative arrays does not occur at this point, but an equivalent effect is obtained by the execution of a line of code which occurs prior to the incrementing of counts and creates entries in the respective associative array only for non-zero counts.

The count alternations function is called on the packed edge that spans the whole of the input text, i.e. the packed edge whose span descriptor matches that of the input text.

countAlternations(PackedEdge):-

if the alternations have already been counted for this packed edge,
then return the previous count and exit this function,
initialise ACounts to zero, (ACounts is an associative array
containing the largest number of times that each alternation occurs
in any analysis), for each individual edge, E, within PackedEdge,

initialise ECounts to zero for each alternation (ECounts keep a
count of the largest number of times each alternation has
occurred in any analysis of E),
let A be the alternation for E,
increment ECounts[A],
for each variable daughter D within E,

find the packed edge, PD, associated with D by the chart
parser,
let DCounts=countAlternations(PD),
for each alternation, DA, with non-zero count in DCounts,

ECounts[DA]=ECounts[DA]+DCounts[DA],

next DA,

next D,
for each alternation, A, with non-zero count in ECounts

ACounts[A] = greater of ACounts[A] and ECounts[A],

next A,

next E,
store ACounts for PackedEdge and mark PackedEdge as having
had its alternations counted,
return ACounts,

End.

As mentioned, the count alternations function is first called on the packed edge that spans the whole of the input text. It then calls itself on each variable daughter of each analysis. The first time this function is called on a packed edge, the results are stored so that the processing is not repeated for that edge.

This method is much more efficient than expanding the analyses, then extracting the alternations to count them.

In the context of the present invention of generating a set of grammar rules for a given language, the count alternations function is applied to the PE (start, finish) of each respective chart produced for a set of phrases in the given language, and the respective sets of alternation counts are combined, i.e. aggregated, to form a single list of the alternations ranked in accordance with their respective count totals.

The invention now proceeds to generate the required set of grammar rules by applying an alternation selection function to the ranked list of alternations. In this embodiment of the present invention, the phrases are arbitrarily allocated unique numbers and ranked in number order and each of the phrases is initially marked as non-fully analysed for the purpose of the operation of the alternation selection function.

The alternation selection function (at step 1) transfers the current highest ranking alternation, or alternations (if two or more alternations have a common total count) to a store for the required set of grammar rules.

The function next (at step 2) primes the agenda of a chart parser with the current content of the store and analyses (at step 3) the highest ranking non-fully analysed phrase of the set of phrases, noting its start and finish vertices.

Then, (at step 4), the function asks the question “does the chart contain a packed edge whose span descriptor corresponds to those start and finish vertices?”. If the answer to that question is “no”, the function goes to step 1.

However, if the answer to that question is “yes”, the function then (at step 6), changes the marking of the currently analysed phrase from non-fully analysed to fully analysed, and (at step 7), asks the question “is there a non-fully analysed phrase?”. If the answer to that question is “no”, the function deems the current content of the store to be the required set of grammar rules and exits, but if the answer to that question is “yes”, the function goes to step 2.

In this way, the required set of grammar rules is built up until it is sufficient to analyse the highest ranking non-fully analysed phrase, and by changing the marking to fully analysed, this ensures that analysed phrases are not re-analysed.

In a variant of this first embodiment, in which the ranked alternations have a membership indicator initially set at “non-member of the required set of rules”, step 1, instead of transferring the current highest ranking alternation(s) to a separate store, toggles the membership indicator of the highest ranking “non-member” alternation(s) to “member(s)”, step 2 primes the agenda of the chart parser with those alternations currently indicated as being members of the required set of grammar rules, and step 6 deems all alternations having their membership indicators set at “member” to constitute the required set of rules.

In respect of the second aspect of the present invention, the user data 171 constitutes a store for storing a set of phrases in a particular language. In practice, the user data 171 will store the corpus of phrase translation pairs, and the set of phrases will be selected from the corpus, either by a user or by a selection program contained within other programs 173. One or more programs contained within other programs 173 constitute in respect of this second aspect, a grammar rule generator; an analysis generator for generating analyses; means for ascertaining alternations of the analyses; means for forming a ranked list of alternations in accordance with a predetermined criterion; alternation selection means; and means for ascertaining, for each phrase of the set of phrases, whether there exists at least one analysis corresponding to the current list of selected alternations acting as grammar rules.

As described above, the modified chart parser algorithm of the present invention will operate until the agenda is empty, and no account is taken of the numbers of edges contained within the packed edges in the chart. In a variant, to reduce the amount of computing resource that would otherwise be required, i.e. memory, processor cycles etc., the algorithm includes a limiter process. This process maintains respective counts of the number of edges contained in each packed edge, and, if the addition of an edge to a packed edge would cause the count to exceed a predetermined limit, then that packed edge is deemed to be full and no more edges are added to it.

A modification of this first embodiment enables the induction of bilingual alternation pairs (grammar rule pairs) which can be used to provide a surface analysis of source and target phrases from a translation pair corpus. This bilingual problem has a number of differences whose solutions require extensions to the monolingual approach.

A first difference is that whereas, in the monolingual case, alternations are counted and ranked, in the bilingual case it is required to count and rank alternation pairs. Thus, it is required to find all possible alternation pairs that could have contributed to the translation of a given source sentence into a given target sentence.

First, the separate monolingual alternations are found for the source and target languages. Then, the source and target monolingual alternations are processed together to find aligned pairs of alternations (grammar rule pairs). In order for a pair of alternations to be deemed to be aligned, also referred herein as admissible, in addition to each of its source and target alternations being a valid monolingual rule, the source and target alternations must have the same common number of variables and a one to one alignment must exist between the variables. An algorithm for finding aligned pairs is described below.

All possible monolingual analyses are generated exactly as in the monolingual case for both the source and the target phrases. It has already been described how to count the monolingual parts of the alternation pairs that contribute to this. It therefore remains to find all admissible source-target pairs of alternations and to count the number of times that they could have taken part in the translation of each example.

The algorithm begins by identifying the criteria which indicate whether a source edge and a target edge could correspond to source and target sides of the same synchronised grammar rule pair. When this is possible, the source and target edges are said to be “alignable”.

To determine whether the source and target edges are alignable, a “signature” is associated with each edge, such that a source edge and a target edge are alignable, if and only if they have the same signature. A method for creating these signatures will now be described.

For a source and target pair of edges to be alignable, their head words must be aligned. Further, they must have the same number of variable daughters and there must exist a one to one mapping between the source daughters and the target daughters.

Each daughter will be associated with a packed edge. The packed edge will represent possible analyses of some defined span in the text. Each daughter within an individual edge can therefore be considered to have a span. Words within this span will include some subset of the head words. For a daughter within a source edge to be alignable with a daughter in a target edge, it is necessary and sufficient that the source head words included in the source daughter's span and the target head words included in the target daughter's span be aligned with one another.

Therefore, it is required that the signatures are to be the same for two edges if and only if
the head words associated with the two edges are aligned,
the two edges have the same number of variable or aligned daughters (no account being taken of literal daughters), and
it is possible to find a one to one alignment between the source and target daughters such that the sets of head words spanned by aligned pairs of daughters are aligned with one another.

The algorithm begins to build the signature by counting the number of source-target head word pairs, say “n”, and assigning a respective unique n-bit word (integer) to each source-target head word pair. Each n-bit word has a respective unique bit which is set to one for its respective source-target head word pair, e.g. 00000001, 00000010, 00000100, etc. Any arbitrary subset of aligned head word pairs is represented by the arithmetic sum of the integers for each head word pair in the subset, e.g. 00010101. The sum of these integers representing a subset of head word pairs is called the “head word subset ID”.

Since each packed edge has a defined span, it will cover a defined set of head words and therefore a head word subset ID can be assigned to each packed edge.

Since each daughter in an individual edge is associated with a span of the text, a head word subset ID can be assigned to each daughter within an edge.

In accordance with the present invention, the signature of an edge is formed as the list, referred to as the signature list of that edge, of head word subset IDs for each of the daughters of that edge and the head word subset ID for the text spanned by the edge, sorted into numeric order.

In the preferred embodiment, a signature string is formed, which is simply the concatenation of the respective n-bit words representing head word subset IDs in the signature list with separators between each such n-bit word.

Now that the manner in which the respective signatures are produced for the edges has been described, the algorithm for counting the occurrence of alternation pairs will now be described.

The starting point is the complete set of monolingual analyses for source and target. The respective head word subset IDs are associated with the packed edges.

Next, the packed source edge is found that spans the whole of the source text, as mentioned this is referred to as the top-level edge. For each individual edge in this packed edge, the respective signature is ascertained. These steps are continued recursively, for each of the daughters of the individual edges, and the whole procedure is repeated for the target edges.

The algorithm is now in a position to count the alternation pairs. Again, starting with the top-level packed edges in each language, the intersection of the signatures between the source and target edges is found. Only individual edges with these signatures will be alignable between the pair of packed edges. For each signature in the intersection, the algorithm selects the subset of source edges and the subset of target edges with this signature. Any edge from the source subset can be aligned with any edge from the target subset.

To derive an alternation pair from a pair of alignable edges, it is necessary to find the one to one mapping between the daughters of the edges. This is achieved by ensuring that source and target daughters which share the same head word subset IDs are replaced by aligned variables in the source and the target alternation. The required alternation can now be formed from the edge.

Having extracted the alternations for the top-level edges, the algorithm proceeds recursively to do the same for each daughter of each alignable edge.

As in the monolingual case, the counts for a given alternation pair are aggregated in the following way.

AltPairCount=0,
For each individual edge, E,

EdgeCount=0,
For each daughter, D,

let DCount be the count for the given alternation pair for D,
let EdgeCount=EdgeCount+DCount,

next daughter,
let AltPairCount = greater of AltPairCount and EdgeCount,

next E
return AltPairCount.

In practice, the frequency counts are cached so that they need to be calculated only once per pair of source-target packed edges.

Next, for each of the aligned pairs and for each of the translation pairs in turn, the respective frequencies of the source alternation are found for each analysis of the respective source phrase, as for the monolingual case, and also the respective frequencies of the target alternation. Now, instead of adding all the respective highest frequencies of an alternation for the source phrases, the bilingual case finds, for each aligned pair of alternations and for each translation pair, the lower of the source highest frequency and the target highest frequency. For example, for a given aligned pair of alternations, the source alternation might have for a given source phrase a frequency of 3, and the corresponding target alternation might have for the corresponding target phrase a frequency of 5. The value of the “frequency” of the aligned pair of alternations which is to be used in the aggregation is the lower of these frequencies, namely 3.

Using this process, a ranked list of the aligned pair of alternations is produced, and the required set of aligned grammar rules is generated by a modified form of the monolingual selection algorithm in which the current highest ranking aligned pair(s) of alternations is removed to the required set, and the current required set is used to prime the agendas of a chart parser.

Another difference between the two cases is that in the monolingual case, the criterion for adding the next ranking alternation(s) to the required set is that, after a source language phrase of a translation pair is analysed by the chart parser, the chart does not contain a packed edge (start, finish), whereas in the bilingual case the criterion for adding the next ranking pair(s) of alternations to the required set is that the chart does not contain a packed edge (start, finish) itself containing an edge corresponding to an analysis tree which permits the construction of a phrase in the target language which is identical to the target language phrase of that translation pair.

Thus, the bilingual version of the selection algorithm stops when all the respective charts contain a packed edge corresponding to start/finish, and each respective packed edge contains an edge which, using the alignment data, will generate the corresponding respective target phrases.

In respect of the fourth aspect of the present invention, the user data 171 constitutes a store for storing a set of phrase translation pairs in a given pair of languages (i.e. a first set of phrases in a first language and a corresponding second set of phrases in a second language). In practice, the user data 171 will store a corpus of phrase translation pairs, and the set of phrase translation pairs will be selected from the corpus, either by a user or by a selection program contained within other programs 173. One or more programs contained within other programs 173 constitute, in respect of this fourth aspect, a grammar rule generator; an analysis generator for generating analyses; means for ascertaining alternations of the analyses; means for ascertaining each alternation of the respective alternations of the first set which is aligned with an alternation of the respective alternations of the second set, each such aligned pair being referred to as an alternation pair; means for forming a ranked list of alternation pairs in accordance with a predetermined criterion; alternation selection means, and means for actually or effectively transferring the current highest ranking alternation pair or alternation pairs to a list of grammar rule pairs and then checking whether there exists, for each phrase of each of the stored phrase translation pairs, at least one analysis corresponding to that list of grammar rule pairs.

An alternative embodiment in accordance with the present invention will now be described.

In practice, the corpus will contain many hundreds of phrase translation pairs, but for the purpose of describing this alternative embodiment, it will be assumed that it contains only the two phrase translation pairs,

the cat sees a dog—le chat voit un chien

and

a bear eats the fish—un ours mange le poisson.

For the first of these phrase translation pairs

the cat sees a dog—le chat voit un chien

the lexical alignment process identifies the word “cat” in the English phrase and the word “chat” in the French phrase as being aligned words, and marks them in the database as being so aligned. In this specification, aligned words are identified by underlining. Thus in the first phrase translation pair, the aligned words “cat” and “chat” are underlined, and similarly for the aligned words “sees” and “voit”, and “dog” and “chien”.

Similarly, for the second phrase translation pair

a bear eats the fish—un ours mange le poisson.

the aligned words are identified by underlining.

The method of this alternative embodiment begins, as before, by assuming that aligned words play the role of headwords, also referred to as heads, in the respective grammars.

The next step of the method of the present invention performs monolingual analysis of the corresponding phrases. Thus, for the first phrase translation pair, the phrase “the cat sees a dog”, which constitutes a sequence of words some of which have been marked as heads, is applied as the input to an English analyser, which constitutes a dependency representation generator of the present invention. This can be expressed alternatively as a monolingual (English) analysis is performed upon the phrase.

The analyser generates a set of all topologically permitted (i.e. legal) analyses, each analysis constituting a dependency representation of the present invention and being in the form of a planar tree wherein all non-headwords, also referred to as literals, are leaves. In a variant, a counter is provided which is incremented for each analysis generated, and the analyser is arranged to check each generated analysis to see whether it consists of a single headword which has every other word as a daughter and to cease to generate further analyses when the count (running total) of generated analyses reaches a predetermined value, provided that at that point there exists such a generated analysis consisting of a single headword which has every other word as a daughter, but if this proviso is not satisfied the analyser continues to generate further analyses until there does exist such a generated analysis.

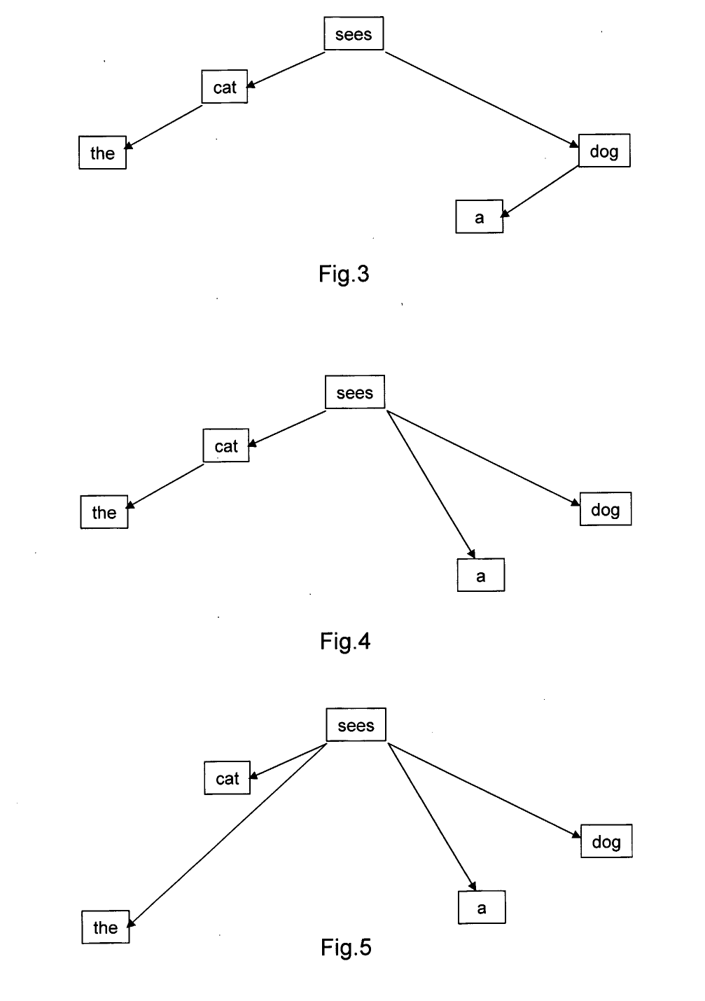

The analyses shown in FIGS. 3 to 40 are expressed by the following respective notations

((the cat) sees (a dog)),
((the cat) sees a (dog)),
(the (cat) sees a (dog)),
(the (cat) sees (a dog)),
(the cat (sees) a (dog)),
(the cat (sees a (dog)),
(the cat (sees (a dog)),
(the cat (sees) (a dog)),
(the cat (sees a) (dog)),
(the cat ((sees a) dog)),
(the cat ((sees) (a dog))),
(the (cat) (sees) a dog),
(the (cat) (sees a) dog),
((the cat) (sees a) dog),
((the cat) (sees) a dog),
(((the cat) sees) a dog),
(((the cat) sees a) dog),
((the (cat) sees a) dog),
((the (cat) sees) a dog),
((a bear) eats (the fish)),
((a bear) eats the (fish)),
(a (bear) eats the (fish)),
(a (bear) eats (the fish)),
(a bear (eats) the (fish)),
(a bear (eats the (fish)),
(a bear (eats (the fish)),
(a bear (eats) (the fish)),
(a bear (eats the) (fish)),
(a bear ((eats the) fish)),
(a bear ((eats) (the fish))),
(a (bear) (eats) the fish),
(a (bear) (eats the) fish),
((a bear) (eats the) fish),
((a bear) (eats) the fish),
(((a bear) eats) the fish),
(((a bear) eats the) fish),
((a (bear) eats the) fish),
((a (bear) eats) the fish).

The next steps in the method of the present invention are:

to take each of the analyses in turn;

to decompose it to determine, i.e. ascertain, the alternations;

to count the number of times that each of the alternations is used in the analysis under consideration;

to assign as the “highest frequency” of an alternation, the greatest number of times that that alternation appears in any of the set of analyses for that phrase; and

to assign as the “aggregate highest frequency” for an alternation, the sum of the frequencies of that alternation for each phrase in the corpus.

Thus, for the analysis of FIG. 3, the occurrences of the alternations are
“the h” (1),
“a h” (1),
“X h Y” (1),
where h is a symbol representing the head of that analysis, and the symbols “X” and “Y” represent placeholders, as is known in the art. The sum of the separate alternations of each analysis for this particular phrase will always be three, since there are three heads.

For the analysis of FIG. 4, the occurrences of the alternations are
“the h” (1),
“X h a Y” (1),
“h” (1).

For the analysis of FIG. 5, the occurrences of the alternations are
“h” (2),
“the X h a Y” (1).

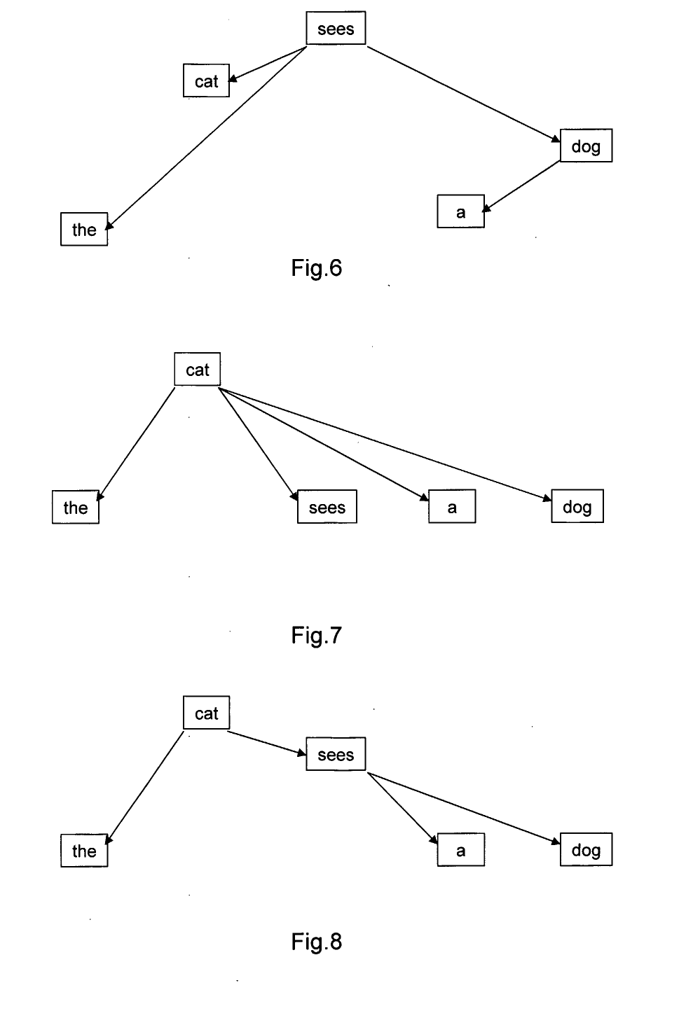

For the analysis of FIG. 6, the occurrences of the alternations are
“h” (1),
“the X h Y” (1),
“a h” (1).

For the analysis of FIG. 7, the occurrences of the alternations are
“the h X a Y” (1),
“h” (2).

For the analysis of FIG. 8, the occurrences of the alternations are
“the h X” (1),
“h a X” (1),
“h” (1).

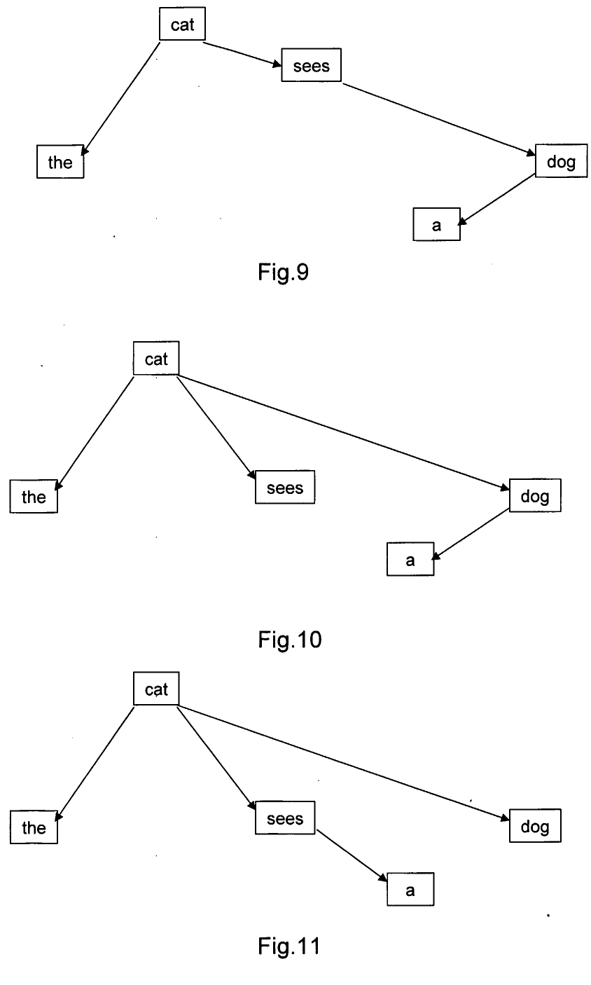

For the analysis of FIG. 9, the occurrences of the alternations are
“the h X” (1),
“h X” (1),
“a h” (1).

For the analysis of FIG. 10, the occurrences of the alternations are
“the h X Y” (1),
“h” (1),
“a h” (1).

For the analysis of FIG. 11, the occurrences of the alternations are
“the h X Y” (1),
“h a” (1),
“h” (1).

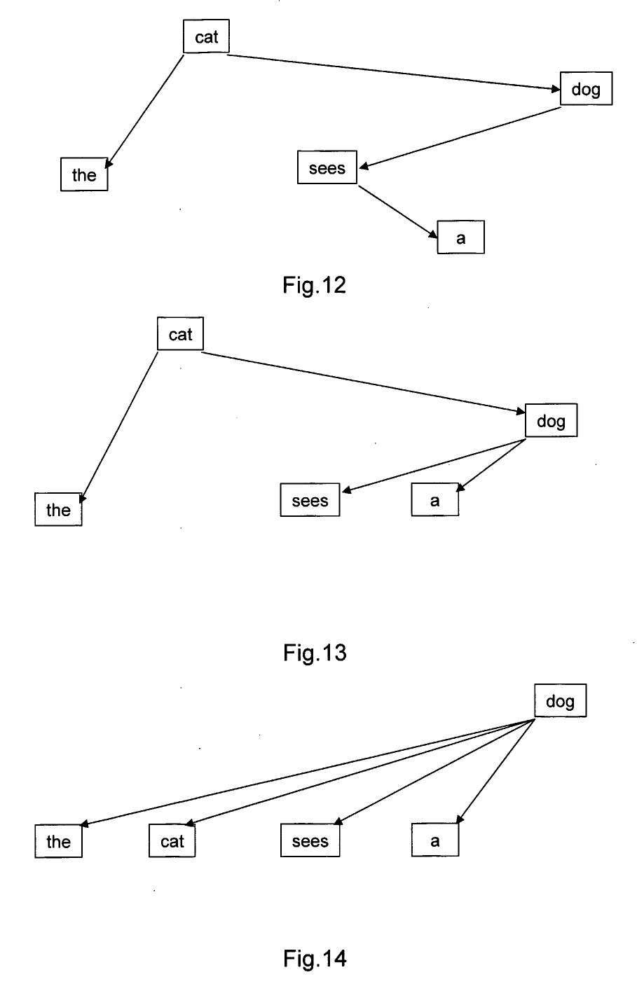

For the analysis of FIG. 12, the occurrences of the alternations are
“the h X” (1),
“X h” (1),
“h a” (1).

For the analysis of FIG. 13, the occurrences of the alternations are
“the h X” (1),
“X h” (1),
“a h” (1).

For the analysis of FIG. 14, the occurrences of the alternations are
“the X Y a h” (1)
“h” (2).

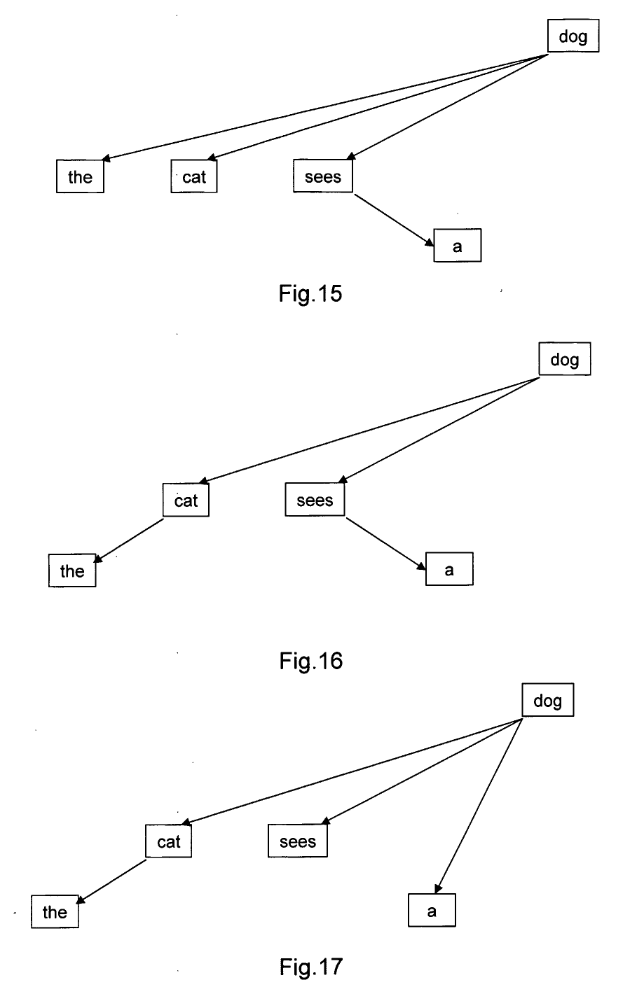

For the analysis of FIG. 15, the occurrences of the alternations are
“the X Y h” (1),
“h a” (1),
“h” (1).

For the analysis of FIG. 16, the occurrences of the alternations are
“X Y h” (1),
“the h” (1),
“h a” (1).

For the analysis of FIG. 17, the occurrences of the alternations are
“X Y a h” (1),
“the h”, (1),
“h a” (1).

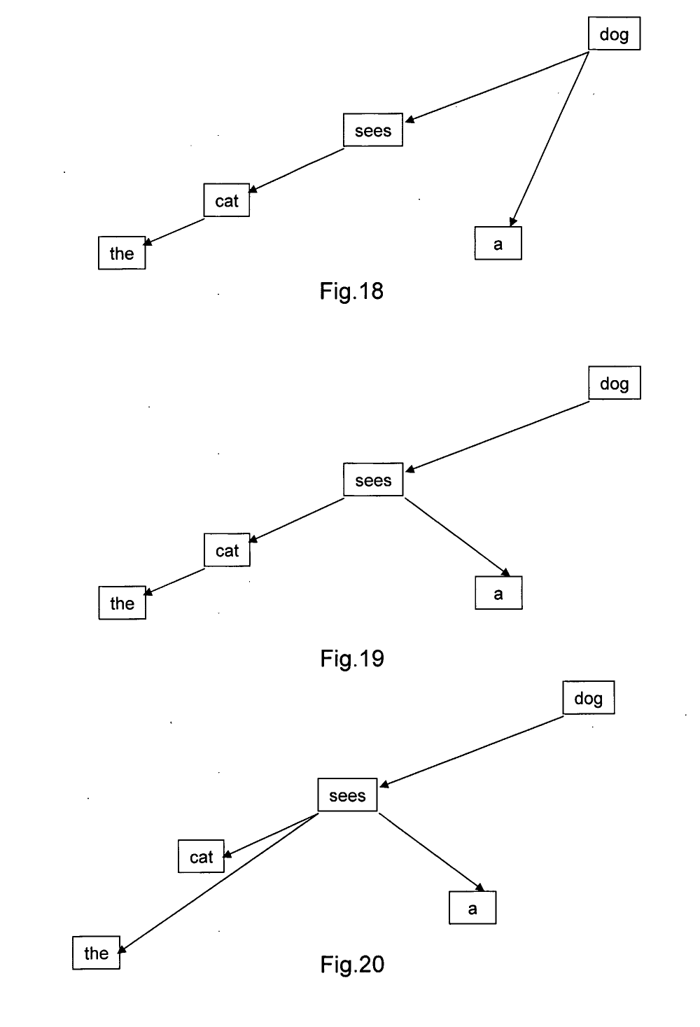

For the analysis of FIG. 18, the occurrences of the alternations are
“X a h” (1),
“the X h” (1),
“a h” (1).

For the analysis of FIG. 19, the occurrences of the alternations are
“X h” (1),
“the X h” (1),
“h a” (1).

For the analysis of FIG. 20, the occurrences of the alternations are
“X h” (1),
“the X h a” (1),
“h” (1)

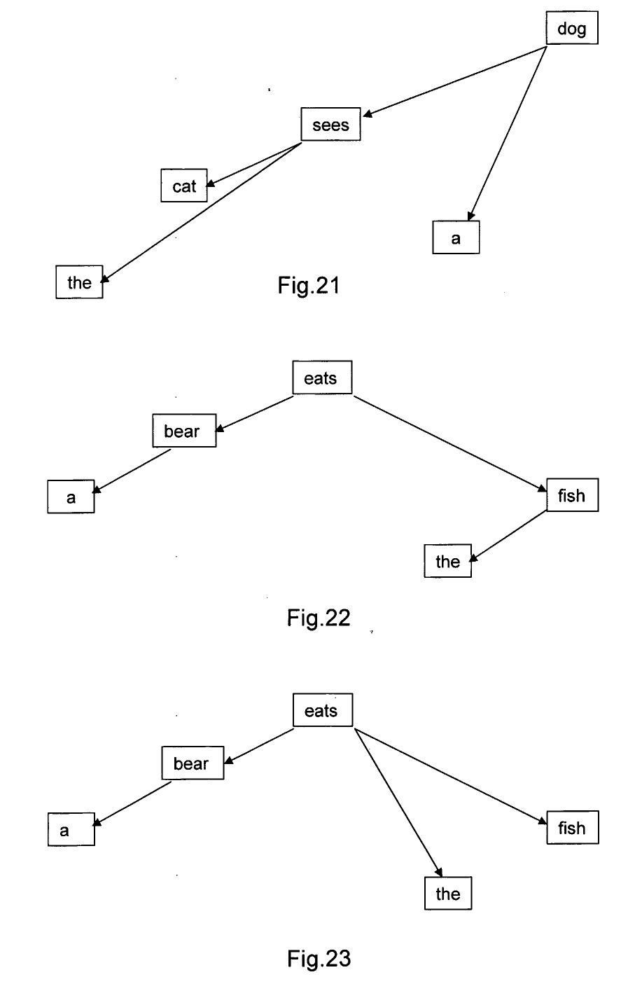

For the analysis of FIG. 21, the occurrences of the alternations are
“X a h” (1),
“the X h” (1),
“the h” (1).

Similarly, for the second pair of phrases

a bear eats the fish—un ours mange le poisson

and again considering only applying the English analyser to the English phrase “a bear eats the fish”, there are again eighteen possible analyses shown respectively in FIGS. 22 to 40.

Thus, for the analysis of FIG. 22, the occurrences of the alternations are
“a h” (1),
“the h” (1),
“X h Y” (1).

For the analysis of FIG. 23, the occurrences of the alternations are
“a h” (1),
“X h the Y” (1),
“h” (1).

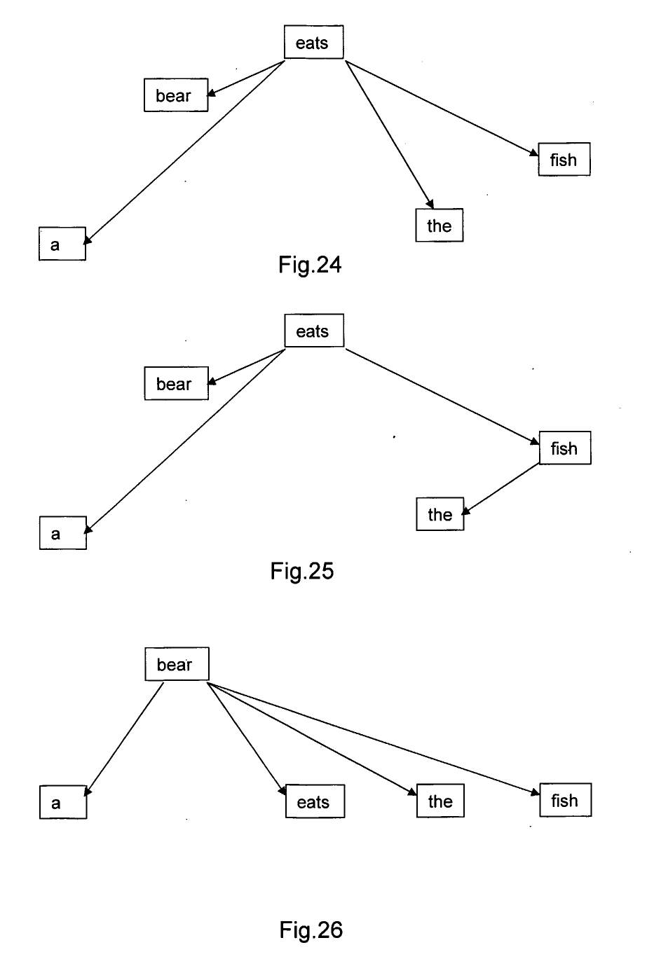

For the analysis of FIG. 24, the occurrences of the alternations are
“h” (2),
“a X h the Y” (1).

For the analysis of FIG. 25, the occurrences of the alternations are
“h” (1),
“a X h Y” (1),
“the h” (1)

For the analysis of FIG. 26, the occurrences of the alternations are
“a h X the Y” (1),
“h” (2).

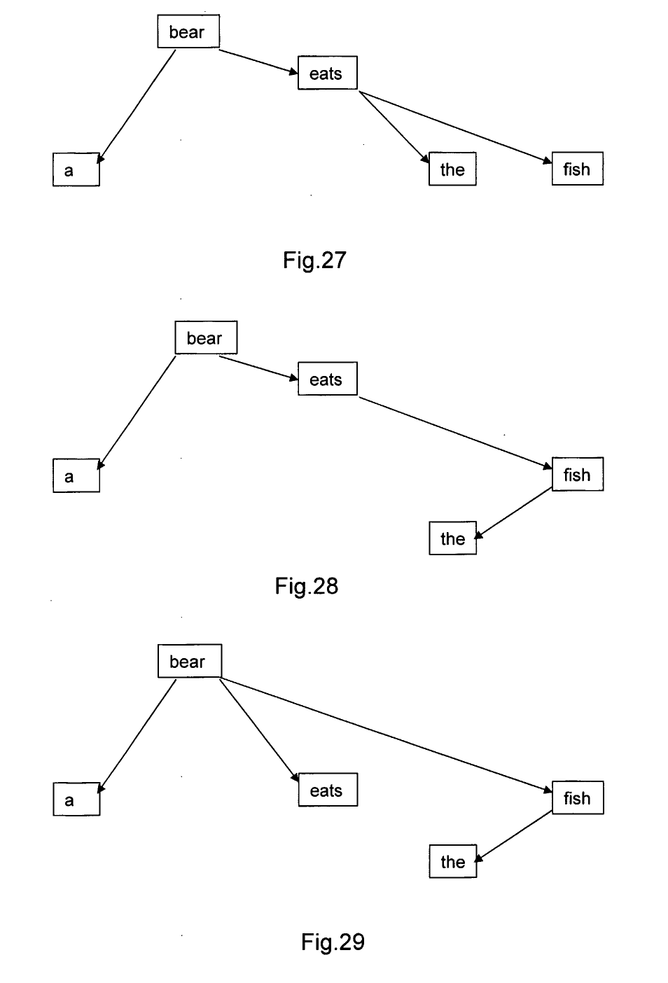

For the analysis of FIG. 27, the occurrences of the alternations are
“a h X” (1),
“h the X” (1),
“h” (1)

For the analysis of FIG. 28, the occurrences of the alternations are
“a h X” (1),
“h X” (1),
“the h” (1)

For the analysis of FIG. 29, the occurrences of the alternations are
“a h X Y” (1),
“h” (1),
“the h” (1)

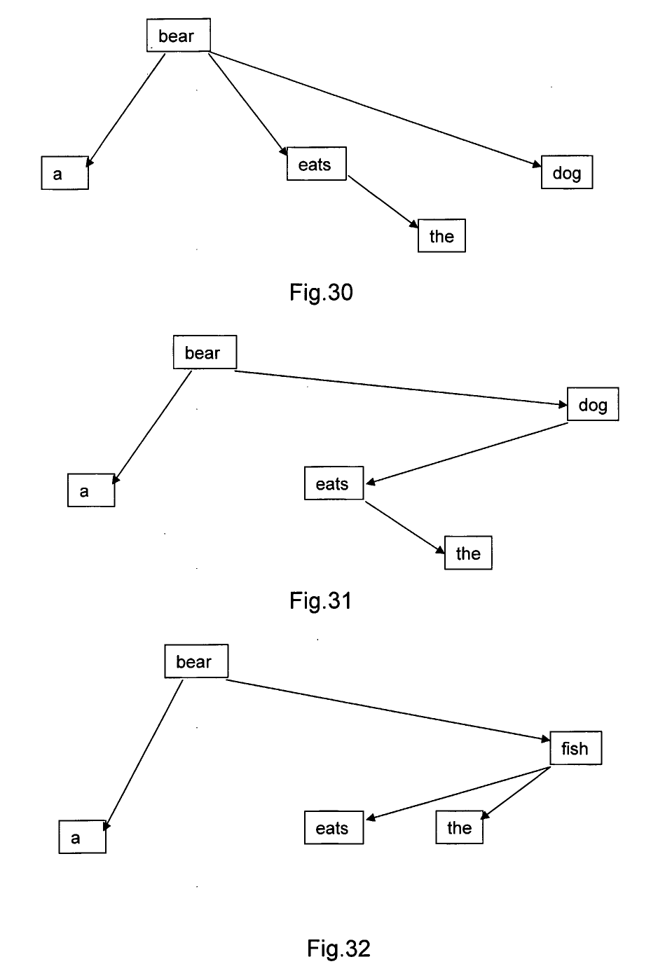

For the analysis of FIG. 30, the occurrences of the alternations are
“a h X Y” (1),
“h the” (1),
“h” (1).

For the analysis of FIG. 31, the occurrences of the alternations are
“a h X” (1),
“X h” (1),
“h the” (1).

For the analysis of FIG. 32, the occurrences of the alternations are
“a h X” (1),
“X h” (1),
“the h” (1).

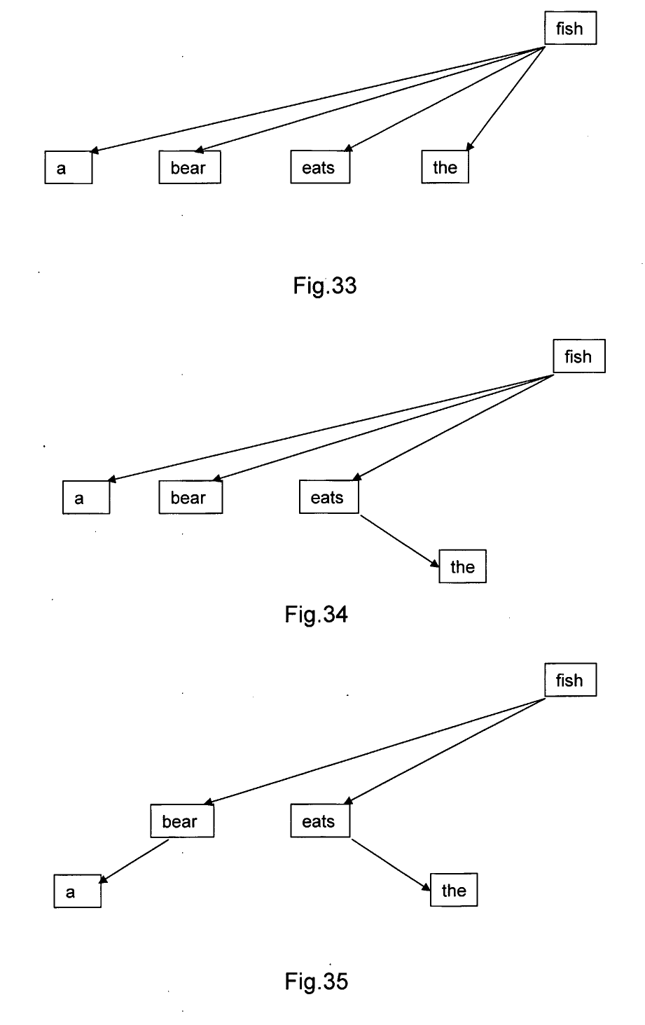

For the analysis of FIG. 33, the occurrences of the alternations are
“a X Y the h” (1)
“h” (2).

For the analysis of FIG. 34, the occurrences of the alternations are
“a X Y h” (1),
“h the” (1),
“h” (1).

For the analysis of FIG. 35, the occurrences of the alternations are
“X Y h” (1),
“the h” (1),
“h the” (1).

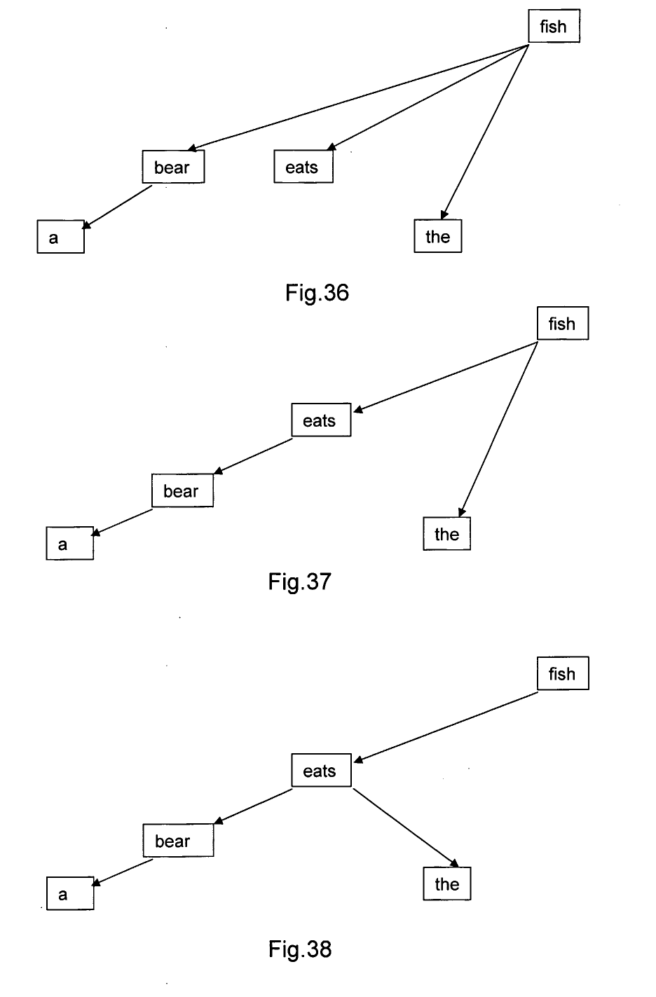

For the analysis of FIG. 36, the occurrences of the alternations are
“X Y the h” (1),
“a h” (1),
“h” (1)

For the analysis of FIG. 37, the occurrences of the alternations are
“X the h” (1),
“a X h” (1),
“the h” (1).

For the analysis of FIG. 38, the occurrences of the alternations are
“X h” (1),
“a X h” (1),
“h the” (1)

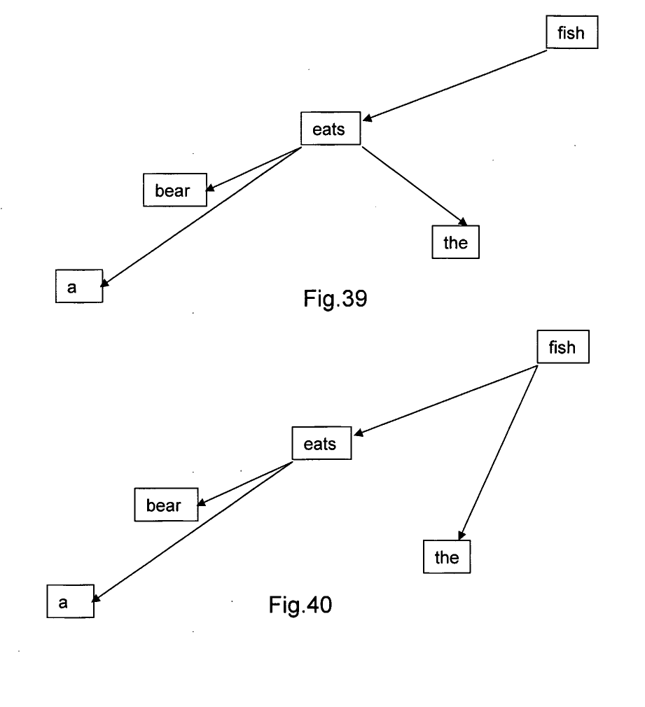

For the analysis of FIG. 39, the occurrences of the alternations are
“X h” (1),
“a X h the” (1),
“h”(1)

For the analysis of FIG. 40, the occurrences of the alternations are
“X the h” (1),
“a X h” (1),
“the h” (1).

For these two phrase translation pairs the alternation frequencies are, ranked greatest first:

| Alternation | first pair/second pair frequency | overall frequency |
|---|---|---|
| h | (2/2) | (4) |
| X h | (1/1) | (2) |
| h X | (1/1) | (2) |
| the h | (1/1) | (2) |
| a h | (1/1) | (2) |
| X h Y | (1/1) | (2) |
| X Y h | (1/1) | (2) |
| h the | (0/1) | (1) |
| h a | (1/0) | (1) |
| the h X | (1/0) | (1) |
| the X h | (1/0) | (1) |
| X the h | (0/1) | (1) |
| the h X Y | (1/0) | (1) |
| a h X Y | (0/1) | (1) |
| h the X | (0/1) | (1) |
| h a X | (1/0) | (1) |
| X Y the h | (0/1) | (1) |
| X Y a h | (1/0) | (1) |
| X h the Y | (0/1) | (1) |
| the X Y h | (1/0) | (1) |
| the X h Y | (1/0) | (1) |
| the h X a Y | (1/0) | (1) |
| a X h the Y | (0/1) | (1) |
| the X Y a h | (1/0) | (1) |
| the X h a | (1/0) | (1) |
| the X h a Y | (1/0) | (1) |
| X a h | (1/0) | (1) |
| a X h | (0/1) | (1) |
| a h X | (0/1) | (1) |
| a X h the | (0/1) | (1) |
| a X Y h | (0/1) | (1) |
| a X Y the h | (0/1) | (1) |
| X h a Y | (1/0) | (1) |

The alternations are selected in rank order to form the required set of grammar rules, and selection ceases when the required set comprises just the first three alternations.

Appendix A

The following steps show part of the full application of the algorithm of the present invention in producing chart entries for the input text “the <dog><sees>the <cat>” where the <word> indicates a headword. To show all the steps that the algorithm performs until the agenda becomes empty would take many pages, so, for convenience, a sufficient number of steps are shown to illustrate the ten features of the algorithm. As an aid in understanding the operation of the algorithm, these features are given the identifiers A1, A2, A3, B1, B2, B21, B31, B32, B41 and B42 in the algorithm and in the following steps.

When the algorithm performs feature A2, i.e. creation from a removed edge of an extended edge for a packed edge in the chart that can extend the removed edge at an extendible side, the newly created extended edge does not contain the packed edge, per se, which can contain many individual edges, but rather a pointer to the packed edge. If, for example, the removed edge has a span descriptor (SD) of (2,3), then, if the removed edge is left active, it can be extended by a packed edge having a span descriptor (SD) of (1,2) and having the identifier “PE (1,2)”, referred to herein as the packed edge PE (1,2), or by a packed edge PE (0,2), and if the removed edge is right active, it can be extended by any packed edge PE (3,m), and the newly created extended edge will contain a respective pointer having the identifier “P(1,2)”, “P(0,2)” or “P(3,m)”, as appropriate. It will be understood that the packed edge is thus a daughter (D) of the newly created extended edge, and of any subsequently created from this edge, and that the pointer associates that daughter with the actual packed edge in the chart.

| Action | Agenda after action | Chart after action |
|---|---|---|
| Prime with inactive | \|<dog>\| : (1,2) : (inactive, left-right | empty |
| heads | augmentable) | |
| | \|<sees>\| : (2,3) : (inactive, left- | |
| | right augmentable) | |
| | \|<cat>\| : (4,5) : (inactive, left-right | |
| | augmentable) | |
| 1. The edge “\|<dog>\| : | (B31) X \|<dog>\| : (1,2) : (left | (B2) PE (1,2) containing: |
| (1,2) : (inactive, left- | active, left-right augmentable) | \|<dog>\| : (1,2) : (inactive, left-right |
| right augmentable)” is | (B32) \|<dog>\| Y : (1,2) : (right | augmentable) |
| removed from the top | active, right augmentable) | |
| of the agenda. It is | (B31) the \|<dog>\| : (1,2) : (left | |
| inactive, so look in the | active, left-right augmentable) | |
| chart to see whether | \|<sees>\| : (2,3) : (inactive, left- | |
| there is a PE having | right augmentable) | |
| the same SD. The | \|<cat>\| : (4,5) : (inactive, left-right | |
| chart is empty, so | augmentable) | |
| create (B2) a PE | | |
| having SD of (1,2), | | |
| and add the edge. | | |
| Also, look in the chart | | |
| to see whether there | | |
| is any active edge that | | |
| the new PE can | | |
| extend. There is none. | | |
| Since the edge is | | |
| inactive, and is | | |
| marked as left-right | | |
| augmentable, create | | |
| (B31, B32) new, active | | |
| edges from it by | | |
| adding (augmenting) | | |
| daughters | | |
| (augmentations) to the | | |
| left and the right of the | | |
| inactive edge. These | | |
| new edges are added | | |
| to the top of the | | |
| agenda for processing | | |
| (shown in bold). | | |
| 2. The edge “X | \|<dog>\| Y : (1,2) : (right active, | PE (1,2) containing: |
| \|<dog>\| : (1,2) : (left | right augmentable) | \|<dog>\| : (1,2) : (inactive, left-right |
| active, left-right | the \|<dog>\| : (1,2) : (left active, | augmentable) |
| augmentable)” is | left-right augmentable) | (A3) X \|<dog>\| : (1,2) : (left active, left- |
| removed from the top | \|<sees>\| : (2,3) : (inactive, left- | right augmentable) |
| of the agenda. It is left | right augmentable) | |
| active with a variable | \|<cat>\| : (4,5) : (inactive, left-right | |
| (X) required. There is | augmentable) | |
| no PE that can extend | | |
| the edge at its left, so | | |
| just (A3) add the | | |
| removed edge to the | | |
| chart. | | |
| 3. The edge “\|<dog>\| | the \|<dog>\| : (1,2) : (left active, | PE (1,2) containing: |
| Y: (1,2) : (right active, | left-right augmentable) | \|<dog>\| : (1,2) : (inactive, left-right |
| right augmentable)” is | \|<sees>\| : (2,3) : (inactive, left- | augmentable) |
| removed from the top | right augmentable) | X \|<dog>\| : (1,2) : (left active, left-right |
| of the agenda. It is | \|<cat>\| : (4,5) : (inactive, left-right | augmentable) |
| right active and the | augmentable) | (A3) \|<dog>\| Y : (1,2) : (right active, right |
| right daughter is a | | augmentable) |
| variable (Y), so check | | |
| to see whether there | | |
| is a PE that can | | |
| extend the edge at its | | |
| right. There is not, so | | |
| just (A3) add the | | |
| removed edge to the | | |
| chart. | | |
| 4. The edge “the | (AD \| the <dog>\| : (0,2) : (inactive, | PE (1,2) containing: |
| \|<dog>\| : (1,2) : (left | left-right augmentable) | \|<dog>\| : (1,2) : (inactive, left-right |
| active, left-right | \|<sees>\| : (2,3) : (inactive, left- | augmentable) |
| augmentable)” is | right augmentable) | X \|<dog>\| : (1,2) : (left active, left-right |
| removed from the top | \|<cat>\| : (4,5) : (inactive, left-right | augmentable) |
| of the agenda. It is left | augmentable) | \|<dog>\| Y : (1,2) : (right active, right |
| active, but this time | | augmentable) |
| requires a literal (the). | | (A3) the \|<dog>\| : (1,2) : (left active, left- |
| The literal is present in | | right augmentable) |
| the text, so the | | |
| removed edge is | | |
| extended (A1) and | | |
| added to the agenda | | |
| (shown in underline). | | |
| The original removed | | |
| edge is added to the | | |
| chart. | | |
| 5. The edge “\| the | (B32) \| the <dog>\| Y : (0,2) : | PE (1,2) containing: |
| <dog>\| : (0,2) : | (right active, right augmentable) | \|<dog>\| : (1,2) : (inactive, left-right |
| (inactive, left-right | \|<sees>\| : (2,3) : (inactive, left- | augmentable) |
| augmentable)” is | right augmentable) | X \|<dog>\| : (1,2) : (left active, left-right |
| removed from the top | \|<cat>\| : (4,5) : (inactive, left-right | augmentable) |
| of the agenda. It is | augmentable) | \|<dog>\| Y : (1,2) : (right active, right |
| inactive, so look in the | | augmentable) |
| chart to see whether | | the \|<dog>\| : (1,2) : (left active, left-right |
| there is a PE having | | augmentable) |
| the same SD (0,2). | | (B2) PE (0,2) containing: |
| There is none. | | \| the <dog>\| : (0,2) : (inactive, left-right |
| Create (B2) a PE | | augmentable) |
| having SD of (0,2) and | | |
| add the edge to it. | | |
| Also, look in the chart | | |
| to see whether there | | |
| is any active edge that | | |
| the new PE can | | |
| extend. There is none. | | |
| Since the edge is | | |
| inactive, and is | | |
| marked as left-right | | |
| augmentable, create | | |
| (B32) a new, active | | |
| edge, and add this to | | |
| the agenda (shown in | | |
| bold). A new left | | |
| active edge cannot be | | |
| created since there | | |
| are no more words to | | |
| the left. | | |
| 6. The edge “\| the | \|<sees>\| : (2,3) : (inactive, left- | PE (1,2) containing: |
| <dog>\| Y : (0,2) : (right | right augmentable) | \|<dog>\| : (1,2) : (inactive, left-right |
| active, right | \|<cat>\| : (4,5) : (inactive, left-right | augmentable) |
| augmentable)” is | augmentable) | X \|<dog>\| : (1,2) : (left active, left-right |
| removed from the top | | augmentable) |
| of the agenda. It is | | \|<dog>\| Y : (1,2) : (right active, right |
| right active, so check | | augmentable) |
| in the input text for a | | the \|<dog>\| : (1,2) : (left active, left-right |
| literal, and in the chart | | augmentable) |
| to see whether there | | PE (0,2) containing: |
| is a PE having an SD | | \| the <dog>\| : (0,2) : (inactive, left-right |
| of the format (2,m). | | augmentable) |
| There is none. | | (A3) \| the <dog>\| Y : (0,2) : (right active, |
| (A3) Add the edge to | | right augmentable) |
| the chart. | | |
| 7. The edge “\|<sees>\| | (B21) \|<dog> (P2,3) \| : (1,3) : | PE (1,2) containing: |
| : (2,3) : (inactive, left- | (inactive, right augmentable) | \|<dog>\| : (1,2) : (inactive, left-right |
| right augmentable)” is | (B21) \|the <dog> (P2,3) \| : (0,3) : | augmentable) |
| removed from the top | (inactive, right augmentable) | X \|<dog>\| : (1,2) : (left active, left-right |
| of the agenda. It is | (B31) X \|<sees>\| : (2,3) : (left | augmentable) |
| inactive, so check in | active, left-right augmentable) | \|<dog>\| Y : (1,2) : (right active, right |
| the chart for a PE of | (B32) \|<sees>\| Y : (2,3) : (right | augmentable) |
| SD (2,3). Create (B2) | active, right augmentable) | the \|<dog>\| : (1,2) : (left active, left-right |
| a PE for SD of (2,3) | (B32) \|<sees>\| the : (2,3) : (right | augmentable) |
| and add the edge. | active, right augmentable) | PE (0,2) containing: |
| Create (B21) | \|<cat>\| : (4,5) : (inactive, left-right | \| the <dog>\| : (0,2) : (inactive, left-right |
| extended edges for | augmentable) | augmentable) |
| active edges in the | | \| the <dog>\| Y : (0,2) : (right active, right |
| chart (shown in | | augmentable) |
| underline) that the | | (B2) PE (2,3) containing: |
| new PE can extend | | \|<sees>\| : (2,3) : (inactive, left-right |
| and add extended | | augmentable) |
| edges to the agenda | | |
| (shown in underline). | | |
| Since the edge is also | | |
| left-right augmentable, | | |
| create (B31, B32) | | |
| new active edges by | | |
| adding left and right | | |
| daughters. These | | |
| new edges are added | | |
| to the agenda as well | | |
| (shown in bold). | | |
| Heads are not allowed | | |
| to be literals as well, | | |
| so there is no | | |
| augmentation to the | | |
| left with a literal ‘dog’. | | |
| 8. The edge “\|<dog> | (B42) \|<dog> (P2,3) \| Z : (1,3) : | PE (1,2) containing: |
| (P2,3) \| : (1,3) : | (right active, right augmentable) | \|<dog>\| : (1,2) : (inactive, left-right |
| (inactive, right | X \|<sees>\| : (2,3) : (left active, | augmentable) |
| augmentable)” is | left-right augmentable) | X \|<dog>\| : (1,2) : (left active, left-right |
| removed from the top | \|<sees>\| Y : (2,3) : (right active, | augmentable) |
| of the agenda. It is | right augmentable) | \|<dog>\| Y : (1,2) : (right active, right |
| inactive, so check in | \|<sees>\| the : (2,3) : (right active, | augmentable) |
| the chart for a PE of | right augmentable) | the \|<dog>\| : (1,2) : (left active, left-right |
| SD (1,3). Create (B2) | \|<cat>\| : (4,5) : (inactive, left-right | augmentable) |
| a PE for SD of (1,3) | augmentable) | PE (0,2) containing: |
| and add the edge. | | \| the <dog>\| : (0,2) : (inactive, left-right |
| Also, look in the chart | | augmentable) |
| to see whether there | | \| the <dog>\| Y : (0,2) : (right active, right |
| is any active edge that | | augmentable) |
| the new PE can | | PE (2,3) containing: |
| extend. There is none. | | \|<sees>\| : (2,3) : (inactive, left-right |
| The edge is also right | | augmentable) |
| augmentable. There is | | (B2) PE (1,3) containing: |
| one possibility (B4) for | | \|<dog> (P2,3) \| : (1,3) : (inactive, right |
| adding daughters to | | augmentable) |
| the right (add a | | |
| variable), so (B42) do | | |
| this to form a new | | |
| edge and add it to the | | |
| agenda (shown in | | |
| bold). | | |
| 9. The edge “\|<dog> | X \|<sees>\| : (2,3) : (left active, | PE (1,2) containing: |
| (P2,3) \| Z : (1,3) : | left-right augmentable) | \|<dog>\| : (1,2) : (inactive, left-right |
| (right active, right | \|<sees>\| Y : (2,3) : (right active, | augmentable) |
| augmentable)” is | right augmentable) | X \|<dog>\| : (1,2) : (left active, left-right |
| removed from the top | \|<sees>\| the : (2,3) : (right active, | augmentable) |
| of the agenda. It is | right augmentable) | \|<dog>\| Y : (1,2) : (right active, right |
| right active, so check | \|<cat>\| : (4,5) : (inactive, left-right | augmentable) |
| in the input text for a | augmentable) | the \|<dog>\| : (1,2) : (left active, left-right |
| literal, and in the chart | | augmentable) |
| to see whether there | | PE (0,2) containing: |
| is a PE having an SD | | \| the <dog>\| : (0,2) : (inactive, left-right |
| of the format (3,m). | | augmentable) |
| There is none. | | \| the <dog>\| Y : (0,2) : (right active, right |
| Add (A3) the edge to | | augmentable) |
| the chart. | | PE (2,3) containing: |
| | | \|<sees>\| : (2,3) : (inactive, left-right |
| | | augmentable) |
| | | PE (1,3) containing: |
| | | \|<dog> (P2,3) \| : (1,3) : (inactive, right |
| | | augmentable) |
| | | (A3) \|<dog> (P2,3) \| Z : (1,3) : (right |
| | | active, right augmentable) |
| 10. The edge “X | (A2) \| (P1,2) <sees>\| : (1,3) : | PE (1,2) containing: |
| \|<sees>\| : (2,3) : (left | (inactive, left-right augmentable) | \|<dog>\| : (1,2) : (inactive, left-right |
| active, left-right | (A2) \| (P0,2) <sees>\| : (0,3) : | augmentable) |
| augmentable)” is | (inactive, left-right augmentable) | X \|<dog>\| : (1,2) : (left active, left-right |
| removed from the top | \|<sees>\| Y : (2,3) : (right active, | augmentable) |
| of the agenda. It is left | right augmentable) | \|<dog>\| Y : (1,2) : (right active, right |
| active, so check in the | \|<sees>\| the : (2,3) : (right active, | augmentable) |
| input text for a literal, | right augmentable) | the \|<dog>\| : (1,2) : (left active, left-right |
| and in the chart to see | \|<cat>\| : (4,5) : (inactive, left-right | augmentable) |
| whether there is a PE | augmentable) | PE (0,2) containing: |
| having an SD of the | | \| the <dog>\| : (0,2) : (inactive, left-right |
| format (n,2). There | | augmentable) |
| are two (shown in | | \| the <dog>\| Y : (0,2) : (right active, right |
| underline). Create | | augmentable) |
| (A2) extended edges | | PE (2,3) containing: |
| from the removed | | \|<sees>\| : (2,3) : (inactive, left-right |
| edge and add them to | | augmentable) |
| the agenda (shown in | | PE (1,3) containing: |
| underline). | | \|<dog> (P2,3) \| : (1,3) : (inactive, right |
| Add the original | | augmentable) |
| removed edge to the | | \|<dog> (P2,3) \| Z : (1,3) : (right active, |
| chart. | | right augmentable) |
| | | (A3) X \|<sees>\| : (2,3) : (left active, left- |
| | | right augmentable) |
| 11. The edge “\| (P1,2) | (B41) the \| X <sees>\| : (1,3) : | PE (1,2) containing: |
| <sees>\| : (1,3) : | (left active, left-right augmentable) | \|<dog>\| : (1,2) : (inactive, left-right |
| (inactive, left-right | (B42) \| X <sees>\| Y : (1,3) : (left | augmentable) |
| augmentable)” is | active, right augmentable) | X \|<dog>\| : (1,2) : (left active, left-right |
| removed from the top | \| (P0,2) <sees>\| : (0,3) : (inactive, | augmentable) |
| of the agenda. It is | left-right augmentable) | \|<dog>\| Y : (1,2) : (right active, right |
| inactive, so check in | \|<sees>\| Y : (2,3) : (right active, | augmentable) |
| the chart for a PE of | right augmentable) | the \|<dog>\| : (1,2) : (left active, left-right |
| SD (1,3). This PE | \|<sees>\| the : (2,3) : (right active, | augmentable) |
| exists, so (B1) add the | right augmentable) | PE (0,2) containing: |
| edge to it. | \|<cat>\| : (4,5) : (inactive, left-right | \| the <dog>\| : (0,2) : (inactive, left-right |
| The edge is also left- | augmentable) | augmentable) |
| right augmentable, so | | \| the <dog>\| Y : (0,2) : (right active, right |
| (B41, B42) create new | | augmentable) |
| active edges by add | | PE (2,3) containing: |
| daughters to the left | | \|<sees>\| : (2,3) : (inactive, left-right |
| and right. Add these | | augmentable) |
| new edges to the | | PE (1,3) containing: |
| agenda (shown in | | \|<dog> (P2,3) \| : (1,3) : (inactive, right |
| bold). | | augmentable) |
| | | (B1) \| (P1,2) <sees>\| : (1,3) : (inactive, |
| | | left-right augmentable) |
| | | \|<dog> (P2,3) \| Z : (1,3) : (right active, |
| | | right augmentable) |
| | | X \|<sees>\| : (2,3) : (left active, left-right |
| | | augmentable) |

1. A method of generating a set of grammar rules for a given language, referred to as the required set of grammar rules, comprising the steps:
(a) acquiring a set of phrases in the given language, those phrases existing in a corpus of phrase translation pairs;
(b) generating a set of grammar rules in respect of the set of phrases;
(c) generating, by an analysis generator and using said set of grammar rules, for each member of the set of phrases, a respective set of analyses;
(d) ascertaining, for each of the analyses, the respective alternations thereof;
(e) ranking the alternations in accordance with a predetermined criterion;
(f) responding to a trigger by actually or effectively transferring the current highest ranking alternation or alternations from the ranked list of alternations to a list of selected alternations and entering a trigger-waiting state; and
(g) responding actually or effectively to the entry of the trigger-waiting state by ascertaining whether there exists, for each member of the stored set of phrases, at least one analysis corresponding to the current list of selected alternations acting as grammar rules, and either generating a said trigger upon a negative outcome or taking no action upon a positive outcome, whereupon in this latter case the current list of selected alternations is then deemed to be the required set of grammar rules.

2. A method as claimed in claim 1, wherein the ranking step (e) comprises the substeps:
(e1) ascertaining, for each analysis for a said phrase, respective frequencies of each of its alternations;
(e2) ascertaining, for all said analyses of the said phrase, respective highest frequencies of each of the alternations;
(e3) repeating substeps (e1) and (e2) for each remaining phrase of said set of phrases and ascertaining, for each of the alternations, the sum of the associated respective highest frequencies; and
(e4) ranking the alternations by their respective sums.

3. A method as claimed in claim 1, wherein said set of grammar rules consists of all possible grammar rules, and wherein, for each member of the set of phrases, its corresponding set of analyses consists of all possible analyses.

4. A method as claimed in claim 1, wherein step (b) is constituted by step (c); and wherein step (c) comprises the substeps:
(c1) parsing each respective member of the set of phrases with a dependency grammar chart parser having an agenda and a chart; and
(c2) forming packed edges in the chart.

5. A method as claimed in claim 4, wherein substep (c1) comprises the substep (c1.1) initialising the agenda with inactive edges formed from headwords identified in the respective member of the set of phrases.

6. A method as claimed in claim 5, wherein substep (c1) further comprises the substep (c1.2) adding to the agenda, for each inactive edge removed from the agenda by the operation of the chart parser, one or more active edges created using said set of grammar rules.

7. A method as claimed in claim 1, wherein step (b) and step (c) are together constituted by generating, by a dependency representation generator, for each member of the set of phrases, a respective set of dependency representations, the dependency representations constituting said analyses.

8. Apparatus for generating a set of grammar rules for a given language, referred to as the required set of grammar rules, comprising:
a store for storing, in use, a set of phrases in the given language, those phrases existing in a corpus of phrase translation pairs;
a grammar rule generator for generating, for a set of phrases in the store, a set of grammar rules in respect of the set of phrases;
an analysis generator arranged to use the generated grammar rules for generating, for each member of the stored set of phrases, a predetermined number of analyses;
means for ascertaining, for each of the analyses, the respective alternations thereof;
means for forming a list of the alternations ranked in accordance with a predetermined criterion;
alternation selection means responsive to a trigger for changing from a quiescent state to an active state in which it actually or effectively transfers the current highest ranking alternation or alternations from the ranked list of alternations to a list of selected alternations and returns to its quiescent state; and
means responsive actually or effectively to the return of the alternation selection means to its quiescent state for ascertaining whether there exists, for each member of the stored set of phrases, at least one analysis corresponding to the current list of selected alternations acting as grammar rules, and being arranged to trigger the alternation selection means upon a negative outcome and to take no action upon a positive outcome, whereupon in this latter case the current list of selected alternations is then deemed to be the required set of grammar rules.

9. Apparatus as claimed in claim 8, wherein the means for forming a list comprises:
means for ascertaining, for a said analysis, respective frequencies of each of the alternations thereof;
means for ascertaining, for all the possible analyses of a said phrase, respective highest frequencies of each of the alternations of those analyses;
means for summing, for all the phrases and for each of the alternations, the associated respective highest frequencies; and
means for ranking the alternations by their respective sums.

10. Apparatus as claimed in claim 8, wherein the analysis generator is a dependency grammar chart parser having an agenda and a chart and arranged to form packed edges in the chart.

11. Apparatus as claimed in claim 10, including means for identifying headwords in a phrase and for initialising the agenda with inactive edges formed from headwords so identified.

12. Apparatus as claimed in claim 11, wherein the grammar rule generator is arranged to add to the agenda, for each inactive edge removed from the agenda by the operation of the chart parser, one or more active edges created as if all possible grammar rules existed.

13. Apparatus as claimed in claim 8, wherein the grammar rule generator and the analysis generator are together constituted by a dependency representation generator, the dependency representations constituting said analyses.

14. A method of generating a set of bilingual grammar rule pairs for a given pair of languages, referred to as the required set of grammar rule pairs, comprising the steps:
(a) acquiring a first set of phrases in a first of the pair of languages and a corresponding second set of phrases in the second of the pair of languages, said first and second sets of phrases constituting a set of phrase translation pairs in the given pair of languages;
(b) generating a set of grammar rules in respect of said first set of phrases;
(c) generating, by an analysis generator and using said possible grammar rules, for each member of said first set of phrases, a predetermined number of analyses;
(d) ascertaining, for each of the analyses, the respective alternations thereof;
(e) applying steps (b) to (d) to said second set of phrases, mutatis mutandi, and
(f) ascertaining each alternation of the respective alternations of said first set of phrases which is aligned with an alternation of the respective alternations of said second set of phrases, each such aligned pair of alternations being referred to as an alternation pair;
(g) ranking the alternation pairs in accordance with a predetermined criterion; and
(h) making the highest ranking alternation pair or alternation pairs a member or members of a set of selected alternation pairs, and similarly for the next highest ranking alternation pair or alternation pairs, and so on, and ceasing when the set of selected alternation pairs acting as grammar rule pairs has become sufficient such that for each member of the set of phrase translation pairs there exists, for each of the phrases of the particular member, at least one analysis corresponding to the set of selected alternation pairs whereupon the current list of selected alternation pairs is then deemed to be the required set of grammar rule pairs.

15. A method as claimed in claim 14, wherein the ranking step (g) comprises the substeps:
(g1) ascertaining, for each analysis for each phrase of a phrase translation pair, respective frequencies of the alternations of each alternation pair;
(g2) ascertaining, for each alternation of an alternation pair and for all the possible analyses of the said phrase, respective highest frequencies of each of the alternations;
(g3) ascertaining, for each alternation pair and for each of the translation pairs, the lower of the highest frequency in respect of the analyses of the phrases in the first language and the highest frequency in respect of the analyses of the phrases in the second language;
(g4) repeating substeps (g1) and (g2) for each remaining phrase of said set of phrases and ascertaining, for each of the alternation pairs, the sum of the associated respective lower highest frequencies; and
(g5) ranking the alternations by their respective sums.

16. A method as claimed in claim 14, wherein said set of grammar rules consists of all possible grammar rules, and said predetermined number of analyses is all possible analyses.

17. A method as claimed in claim 14, wherein step (b) is constituted by step (c); and wherein step (c) comprises the substeps:
(c1) parsing each respective member of the first set of phrases with a dependency grammar chart parser having an agenda and a chart; and
(c2) forming packed edges in the chart.

18. A method as claimed in claim 17, wherein substep (c1) comprises the substep (c1.1) initialising the agenda with inactive edges formed from headwords identified in the respective member of the first set of phrases.

19. A method as claimed in claim 18, wherein substep (c1) further comprises the substep (c1.2) adding to the agenda, for each inactive edge removed from the agenda by the operation of the chart parser, one or more active edges created using said set of grammar rules.

20. A method as claimed in claim 14, wherein step (b) and step (c) are together constituted by generating, by a dependency representation generator, for each member of the first set of phrases, a respective set of dependency representations, the dependency representations constituting said analyses.

21. Apparatus for generating a set of bilingual grammar rule pairs for a given pair of languages, referred to as the required set of grammar rule pairs, comprising:
a store for storing a first set of phrases in a first of the pair of languages and a corresponding second set of phrases in the second of the pair of languages, said first and second sets of phrases constituting a set of phrase translation pairs in the given pair of languages;
a grammar rule generator for generating, for a stored set of phrases, a set of grammar rules in respect of the set of phrases;
an analysis generator arranged to use the generated grammar rules for generating, for each member of the stored set of phrases, a predetermined number of analyses;
means for ascertaining, for each of the analyses, the respective alternations thereof; means for ascertaining each alternation of the respective alternations of said first set of phrases which is aligned with an alternation of the respective alternations of said second set of phrases, each such aligned pair of alternations being referred to as an alternation pair;
means for forming a list of the alternation pairs ranked in accordance with a predetermined criterion; and
means for creating the required set of grammar rule pairs by repeated operation of actually or effectively transferring the current highest ranking alternation pair or alternation pairs from the ranked list of alternation pairs to a list of grammar rule pairs and then checking whether there exists, for each phrase of each member of the stored set of phrase translation pairs, at least one analysis corresponding to that list of grammar rule pairs, and being arranged to cease operation upon a positive outcome of that check, the said list of grammar rule pairs being then deemed to be the required set of grammar rule pairs.

22. Apparatus as claimed in claim 21, wherein the means for forming a list comprises:
means for ascertaining, for a said analysis, respective frequencies of each of the alternations thereof;
means for ascertaining, for all the possible analyses of a said phrase, respective highest frequencies of each of the alternations of those analyses;
means for ascertaining, for each alternation pair and for each of the translation pairs, the lower of the highest frequency in respect of the analyses of the phrases in the first language and the highest frequency in respect of the analyses of the phrases in the second language;
means for summing, for all the phrases and for each of the alternations, the associated respective lower highest frequencies; and
means for ranking the alternations by their respective sums.

23. Apparatus as claimed in claim 21, wherein the analysis generator is a dependency grammar chart parser having an agenda and a chart and arranged to form packed edges in the chart.

24. Apparatus as claimed in claim 23, including means for identifying headwords in a phrase and for initialising the agenda with inactive edges formed from headwords so identified.

25. Apparatus as claimed in claim 24, wherein the grammar rule generator is arranged to add to the agenda, for each inactive edge removed from the agenda by the operation of the chart parser, one or more active edges created as if all possible grammar rules existed.

26. Apparatus as claimed in claim 21, wherein the grammar rule generator and the analysis generator are together constituted by a dependency representation generator, the dependency representations constituting said analyses.
